(19) United States
(12) Patent Application Publication
(10) Pub. No.: US 2015/0088982 A1
(43) Pub. Date: Mar. 26, 2015

(54) LOAD BALANCED INTER-DEVICE MESSAGING

(71) Applicant: Weaved, Inc., Palo Alto, CA (US)

(72) Inventors: Michael W. Johnson, Petaluma, CA (US); Ryo Koyama, Palo Alto, CA (US); Michael J.S. Smith, Palo Alto, CA (US)

(21) Appl. No.: 14/534,155

(22) Filed: Nov. 5, 2014

Related U.S. Application Data
(63) Continuation-in-part of application No. 13/865,910, filed on Apr. 18, 2013.
Application No. 13/865,910 is a continuation of application No. 11/860,876, filed on Sep. 25, 2007, now Pat. No. 8,447,843.
(60) Provisional application No. 60/883,637, filed on Jan. 5, 2007.
(60) Provisional application No. 60/826,887, filed on Sep. 25, 2006.

(51) Int. Cl. H04L 29/08; H04L 12/803

(52) U.S. Cl. CPC H04L 67/1004; H04L 47/125
USPC 709/203

(57) ABSTRACT

The present disclosure provides a detailed description of techniques used in methods, systems, and computer program products for using multiple connection URLs to enable load balanced inter-device messaging. The claimed embodiments address the problem of cost-effectively scaling the communications with an increasing number of devices connected to the Internet. More specifically, the claimed embodiments are directed to approaches for registering a listener device (e.g., mobile phone or handset) to receive messages from one or more notification devices (e.g., web camera), selecting a notification server from multiple servers to receive each notification message (e.g., using multiple URLs) and forward the message (e.g., through a push service) to the listener device. The selection of the notification server can be based on load balancing the multiple servers.

### RELATED APPLICATIONS

The present application is a continuation-in-part of U.S. Ser. No. 13/865,910 filed Apr. 18, 2013, titled “SYSTEM, METHOD AND COMPUTER PROGRAM PRODUCT FOR IDENTIFYING, CONFIGURING AND ACCESSING A DEVICE ON A NETWORK”, which is a continuation of Ser. No. 11/860,876 filed Sep. 25, 2007 (now U.S. Pat. No. 8,447,843); which claims the benefit of priority from U.S. provisional application Ser. No. 60/883,637 filed Jan. 5, 2007; and claims the benefit of priority from U.S. provisional application Ser. No. 60/826,887, filed Sep. 25, 2006, all of which are hereby incorporated by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

This disclosure relates to the field of Internet networking and more particularly to techniques for using multiple connection URLs to enable load balanced inter-device messaging. Embodiments of the present disclosure generally relate to improvements to networked computing devices and, more specifically, to efficient use of CPUs in various devices.

### BACKGROUND

As increasingly more devices (e.g., servers, computers, phones, equipment, cameras, appliances, etc.) are connected to the Internet, the need to connect them in a meaningful, fast, secure, and cost-effective way becomes increasingly difficult. Specific scalability challenges related to managing the messaging between devices are evident.

There are legacy approaches that enable inter-device communication (e.g., between a home security camera and a homeowner's smartphone). However, these legacy techniques are not well suited to quickly and cost-effectively enable communications from a large number of devices (e.g., all security cameras of a multi-national corporation). Specific challenges arise in balancing the connection and messaging load on the communication system servers. Techniques are therefore needed to address the problem of cost-effectively scaling the communications with an increasing number of devices connected to the Internet.

None of the aforementioned legacy approaches achieve the capabilities of the herein-disclosed techniques for using multiple connection URLs to enable load balanced inter-device messaging. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for using multiple connection URLs to enable load balanced inter-device messaging. The claimed embodiments address the problem of cost-effectively scaling the communications with an increasing number of devices connected to the Internet. More specifically, some claims are directed to approaches for using multiple device connection URLs to enable DNS load balancing for redundancy and scalability, which claims advance the technical fields for addressing the problem of cost-effectively scaling the communications with an increasing number of devices connected to the Internet, as well as advancing peripheral technical fields. Some claims improve the functioning of multiple systems within the disclosed environments.

More specifically, the claimed embodiments are directed to approaches for registering a listener device (e.g., mobile phone or handset) to receive messages from one or more notification devices (e.g., web camera), selecting a notification server from multiple servers to receive each notification message (e.g., using multiple URLs) and forwarding the message (e.g., through a push service) to the listener device. In some embodiments, the selection of the notification server is based on load balancing the multiple servers. In other embodiments, the notification server can be randomly selected.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

So that the features of various embodiments of the present disclosure can be understood, a more detailed description, briefly summarized above, may be had by reference to various embodiments, some of which are illustrated in the accompanying drawings. It is to be noted, however, that the accompanying drawings illustrate only embodiments and are therefore not to be considered limiting of the scope of the various embodiments of the disclosure, for the embodiment(s) may admit to other effective embodiments. The following detailed description makes reference to the accompanying drawings that are now briefly described.

The drawings described below are for illustration purposes only. The drawings are not intended to limit the scope of the present disclosure.

One or more of the various embodiments of the disclosure are susceptible to various modifications, combinations, and alternative forms, various embodiments thereof are shown by way of example in the drawings and will herein be described in detail. It should be understood, however, that the accompanying drawings and detailed description are not intended to limit the embodiment(s) to the particular form disclosed, but on the contrary, the intention is to cover all modifications, combinations, equivalents and alternatives falling within the spirit and scope of the various embodiments of the present disclosure as defined by the relevant claims.

FIG. 1A is an environment that supports using multiple connection URLs to enable load balanced inter-device messaging, according to some embodiments.

FIG. 1B is a block diagram depicting a system for using multiple connection URLs to enable load balanced inter-device messaging, according to some embodiments.

FIG. 2 is a diagram showing a notification device protocol for use in systems that use multiple connection URLs to enable load balanced inter-device messaging, according to some embodiments.

FIG. 3A is a diagram showing a listener device protocol for use in systems that use multiple connection URLs to enable load balanced inter-device messaging, according to some embodiments.

FIG. 3B presents usage scenarios of an application programming interface for listener devices in systems that use multiple connection URLs to enable load balanced inter-device messaging, according to some embodiments.

FIG. 4 is a block diagram of a system for implementing all or portions of any of the embodiments described herein.

FIG. 5A, FIG. 5B, FIG. 5C, and FIG. 5D depict exemplary architectures of components suitable for implementing embodiments of the present disclosure, and/or for use in the herein-described environments.

### DETAILED DESCRIPTION

### Glossary

In this description a device refers to a mobile device, electronic system, machine, and/or any type of apparatus, system, that may be mobile, fixed, wearable, portable, integrated, cloud-based, distributed and/or any combination of these and which may be formed, manufactured, operated, etc. in any fashion, or manner in any location(s). It should be understood, however, that one or more of the embodiments described herein and/or in one or more specifications incorporated by reference may be applied to any device(s) or similar object(s) e.g., consumer devices, phones, phone systems, cell phones, cellular phones, mobile phone, smart phone, internet phones, wireless phones, personal digital assistants (PDAs), remote communication devices, wireless devices, music players, video players, media players, multimedia players, video recorders, VCRs, DVRs, book readers, voice recorders, voice controlled systems, voice controllers, cameras, social interaction devices, radios, TVs, watches, personal communication devices, electronic wallets, electronic currency, smart cards, smart credit cards, electronic money, electronic coins, electronic tokens, smart jewelry, electronic passports, electronic identification systems, biometric sensors, biometric systems, biometric devices, smart pens, smart rings, personal computers, tablets, laptop computers, scanners, printers, computers, web servers, media servers, multimedia servers, file servers, datacenter servers, database servers, database appliances, cloud servers, cloud devices, cloud appliances, embedded systems, embedded devices, electronic glasses, electronic goggles, electronic screens, displays, wearable displays, projectors, picture frames, touch screens, computer appliances, kitchen appliances, home appliances, home theater systems, audio systems, home control appliances, home control systems, irrigation systems, sprinkler systems, garage door systems, garage door controls, remote controls, remote control systems, thermostats, heating systems, air conditioning systems, ventilation systems, climate control systems, climate monitoring systems, industrial control systems, transportation systems and controls, industrial process and control systems, industrial controller systems, machine-to-machine systems, aviation systems, locomotive systems, power control systems, power controllers, lighting control, lights, lighting systems, solar system controllers, solar panels, vehicle and other engines, engine controllers, motors, motor controllers, navigation controls, navigation systems, navigation displays, sensors, sensor systems, transducers, transducer systems, computer input devices, device controllers, touchpads, mouse, pointer, joystick, keyboards, game controllers, haptic devices, game consoles, game boxes, network devices, routers, switches, TiVO, AppleTV, GoogleTV, internet TV boxes, internet systems, internet devices, set-top boxes, cable boxes, modems, cable modems, PCs, tablets, media boxes, streaming devices, entertainment centers, entertainment systems, aircraft entertainment systems, hotel entertainment systems, car and vehicle entertainment systems, GPS devices, GPS systems, automobile and other motor vehicle systems, truck systems, vehicle control systems, vehicle sensors, aircraft systems, automation systems, home automation systems, industrial automation systems, reservation systems, check-in terminals, ticket collection systems, admission systems, payment devices, payment systems, banking machines, cash points, ATMs, vending machines, vending systems, point of sale devices, coin-operated devices, token operated devices, gas (petrol) pumps, ticket machines, toll systems, barcode scanners, credit card scanners, travel token systems, travel card systems, RFID devices, electronic labels, electronic tags, tracking systems, electronic stickers, electronic price tags, near field communication (NFC) devices, wireless operated devices, wireless receivers, wireless transmitters, sensor devices, motes, sales terminals, checkout terminals, electronic toys, toy systems, gaming systems, information appliances, information and other kiosks, sales displays, sales devices, electronic menus, coupon systems, shop displays, street displays, electronic advertising systems, traffic control systems, traffic signs, parking systems, parking garage devices, elevators and elevator systems, building systems, mailboxes, electronic signs, video cameras, security systems, surveillance systems, electronic locks, electronic keys, electronic key fobs, access devices, access controls, electronic actuators, safety systems, smoke detectors, fire control systems, fire detection systems, locking devices, electronic safes, electronic doors, music devices, storage devices, back-up devices, USB keys, portable disks, exercise machines, sports equipment, medical devices, medical systems, personal medical devices, wearable medical devices, portable medical devices, mobile medical devices, blood pressure sensors, heart rate monitors, blood sugar monitors, vital sign monitors, ultrasound devices, medical imagers, drug delivery systems, drug monitoring systems, patient monitoring systems, medical records systems, industrial monitoring systems, robots, robotic devices, home robots, industrial robots, electric tools, power tools, construction equipment, electronic jewelry, wearable devices, wearable electronic devices, wearable cameras, wearable video cameras, wearable systems, electronic dispensing systems, handheld computing devices, handheld electronic devices, electronic clothing, combinations of these and/or any other devices, multi-function devices, multi-purpose devices, combination devices, cooperating devices, and the like, etc.

The devices may support (e.g., include, comprise, contain, implement, execute, be part of, be operable to execute, display, source, provide, store, etc.) one or more applications and/or functions e.g., search applications, contacts and/or friends applications, social interaction applications, social media applications, messaging applications, telephone applications, video conferencing applications, e-mail applications, voicemail applications, communications applications, voice recognition applications, instant messaging (IM) applications, texting applications, blog and/or blogging applications, photographic applications (e.g., catalog, management, upload, editing, etc.), shopping, advertising, sales, purchasing, selling, vending, ticketing, payment, digital camera applications, digital video camera applications, web browsing and browser applications, digital music player applications, digital video player applications, cloud applications, office productivity applications, database applications, cataloging applications, inventory control, medical applications, electronic book and newspaper applications, travel applications, dictionary and other reference work applications, language translation, spreadsheet applications, word processing applications, presentation applications, business applications, finance applications, accounting applications, publishing applications, web authoring applications, multimedia editing, computer-aided design (CAD), manufacturing applications, home automation and control, backup and/or storage applications, help and/or manuals, banking applications, stock trading applications, calendar applications, voice driven applications, map applications, consumer entertainment applications, games, other applications and/or combinations of these and/or multiple instances (e.g., versions, copies, etc.) of these and/or other applications, and the like, etc.

The devices may include (e.g., comprise, be capable of including, have features to include, have attachments, communicate with, be linked to, be coupled with, operable to be coupled with, be connected to, be operable to connect to, etc.) one or more devices (e.g., there may be a hierarchy of devices, nested devices, etc.). The devices may operate, function, run, etc. as separate components, working in cooperation, as a cooperative hive, as a confederation of devices, as a federation, as a collection of devices, as a cluster, as a multi-function device, with sockets, ports, connectivity, etc. for extra, additional, add-on, optional, etc. devices and/or components, attached devices (e.g., direct attach, network attached, remote attach, cloud attach, add on, plug in, etc.), upgrade components, helper devices, acceleration devices, support devices, engines, expansion devices and/or modules, combinations of these and/or other components, hardware, software, firmware, devices, and the like, etc.

The devices may have (e.g., comprise, include, execute, perform, capable of being programmed to perform, etc.) one or more device functions (e.g., telephone, video conferencing, e-mail, instant messaging, blogging, digital photography, digital video, web browsing, digital music playing, social interaction, shopping, searching, banking, combinations of these and/or other functions, and the like, etc.). Instructions, help, guides, manuals, procedures, algorithms, processes, methods, techniques, etc. for performing and/or helping to perform, etc. the device functions, etc. may be included in a computer readable storage medium, computer readable memory medium, or other computer program product configured for execution, for example, by one or more processors.

The devices may include one or more processors (e.g., central processing units (CPUs), multicore CPUs, homogeneous CPUs, heterogeneous CPUs, graphics processing units (GPUs), computing arrays, CPU arrays, microprocessors, controllers, microcontrollers, engines, accelerators, compute arrays, programmable logic, DSP, combinations of these and the like, etc.). Devices and/or processors, etc. may include, contain, comprise, etc. one or more operating systems (OSs). Processors may use one or more machine or system architectures (e.g., ARM, Intel, x86, hybrids, emulators, other architectures, combinations of these, and the like, etc.).

Processor architectures may use one or more privilege levels. For example, the x86 architecture may include four hardware resource privilege levels or rings. The OS kernel, for example, may run in privilege level 0 or ring 0 with complete control over the machine or system. In the Linux OS, for example, ring 0 may be kernel space, and user mode may run in ring 3.

A multi-core processor (multicore processor, multicore CPU, etc.) may be a single computing component (e.g., a single chip, a single logical component, a single physical component, a single package, an integrated circuit, a multi-chip package, combinations of these and the like, etc.). A multicore processor may include (e.g., comprise, contain, etc.) two or more central processing units, etc. called cores. The cores may be independent, relatively independent and/or connected, coupled, integrated, logically connected, etc. in any way. The cores, for example, may be the units that read and execute program instructions. The instructions may be ordinary CPU instructions such as add, move data, and branch, but the multiple cores may run multiple instructions at the same time, increasing overall speed, for example, for programs amenable to parallel computing. Manufacturers may typically integrate the cores onto a single integrated circuit die (known as a chip multiprocessor or CMP), or onto multiple dies in a single chip package, but any implementation, construction, assembly, manufacture, packaging method and/or process, etc. is possible.

The devices may use one or more virtualization methods. In computing, virtualization refers to the act of creating (e.g., simulating, emulating, etc.) a virtual (rather than actual) version of something, including but not limited to a virtual computer hardware platform, operating system (OS), storage device, computer network resources and the like.

For example, a hypervisor or virtual machine monitor (VMM) may be a virtualization method and may allow (e.g., permit, implement, etc.) hardware virtualization. A hypervisor may run (e.g., execute, operate, control, etc.) one or more operating systems (e.g., guest OSs, etc.) simultaneously (e.g., concurrently, at the same time, at nearly the same time, in a time multiplexed fashion, etc.), and each may run on its own virtual machine (VM) on a host machine and/or host hardware (e.g., device, combination of devices, combinations of devices with other computer(s), etc.). A hypervisor, for example, may run at a higher level than a supervisor.

Multiple instances of OSs may share virtualized hardware resources. A hypervisor, for example, may present a virtual platform, architecture, design, etc. to a guest OS and may monitor the execution of one or more guest OSs. A Type 1 hypervisor (also type I, native, or bare metal hypervisor, etc.) may run directly on the host hardware to control the hardware and monitor guest OSs. A guest OS thus may run at a level above (e.g., logically above, etc.) a hypervisor. Examples of Type 1 hypervisors may include VMware ESXi, Citrix XenServer, Microsoft Hyper-V, etc. A Type 2 hypervisor (also type II, or hosted hypervisor) may run within a conventional OS (e.g., Linux, Windows, Apple iOS, etc.). A Type 2 hypervisor may run at a second level (e.g., logical level, etc.) above the hardware. Guest OSs may run at a third level above a Type 2 hypervisor. Examples of Type 2 hypervisors may include VMware Server, Linux KVM, VirtualBox, etc. A hypervisor thus may run one or more other hypervisors with their associated VMs. In some cases, virtualization and nested virtualization may be part of an OS. For example, Microsoft Windows 7 may run Windows XP in a VM. For example, the IBM turtles project, part of the Linux KVM hypervisor, may run multiple hypervisors (e.g., KVM and VMware, etc.) and operating systems (e.g., Linux and Windows, etc.). The term embedded hypervisor may refer to a form of hypervisor that may allow, for example, one or more applications to run above the embedded hypervisor without an OS.

The term hardware virtualization may refer to virtualization of machines, devices, computers, operating systems, combinations of these, etc. that may hide the physical aspects of a computer system and instead present (e.g., show, manifest, demonstrate, etc.) an abstract system (e.g., view, aspect, appearance, etc.). For example, x86 hardware virtualization may allow one or more OSs to share x86 processor resources in a secure, protected, safe, etc. manner. Initial versions of x86 hardware virtualization were implemented using software techniques to overcome the lack of processor virtualization support. Manufacturers (e.g., Intel, AMD, etc.) later added (e.g., in later generations, etc.) processor virtualization support to x86 processors, thus simplifying later versions of x86 virtualization software, etc. Continued addition of hardware virtualization features to x86 and other (e.g., ARM) processors has resulted in continued improvements (e.g., in speed, in performance, etc.) of hardware virtualization. Other virtualization methods, such as memory virtualization, I/O virtualization (IOV), etc. may be performed by a chipset, integrated with a CPU, and/or by other hardware components, etc. For example, an input/output memory management unit (IOMMU) may enable guest VMs to access peripheral devices (e.g., network adapters, graphics cards, storage controllers, etc.) e.g., using DMA, interrupt remapping, etc. For example, PCI-SIG IOV may use a set of general (e.g., non-x86 specific) PCI Express (PCI-E) based native hardware I/O virtualization techniques. For example, one such technique may be address translation services (ATSs) that may support native IOV across PCI-E using address translation. For example, single root IOV (SR-IOV) may support native IOV in single root complex PCI-E topologies. For example, multi-root IOV (MR-IOV) may support native IOV by expanding SR-IOV to provide multiple root complexes that may, for example, share a common PCI-E hierarchy. In SR-IOV, for example, a host VMM may configure supported devices to create and allocate virtual shadows of configuration spaces (e.g., shadow devices, etc.) so that VM guests may, for example, configure, access, etc. one or more shadow device resources.

The devices (e.g., device software, device firmware, device applications, OSs, combinations of these, etc.) may use one or more programs (e.g., source code, programming languages, binary code, machine code, applications, apps, functions, etc.). The programs, etc. may use (e.g., require, employ, etc.) one or more code translation techniques (e.g., process, algorithms, etc.) to translate from one form of code to another form of code e.g., to translate from source code (e.g., readable text, abstract representations, high-level representations, graphical representations, etc.) to machine code (e.g., machine language, executable code, binary code, native code, low-level representations, etc.). For example, a compiler may translate (e.g., compile, transform, etc.) source code into object code (e.g., compiled code, etc.). For example, a linker may translate object code into machine code (e.g., linked code, loadable code, etc.). Machine code may be executed by a CPU, etc. at runtime. Computer programming languages (e.g., high-level programming languages, source code, abstract representations, etc.) may be interpreted or compiled. Interpreted code may be translated (e.g., interpreted, by an interpreter, etc.), for example, to machine code during execution (e.g., at runtime, continuously, etc.). Compiled code may be translated (compiled, by a compiler, etc.), for example, to machine code once (e.g., statically, at one time, etc.) before execution. An interpreter may be classified into one or more of the following types: type 1 interpreters may, for example, execute source code directly; type 2 interpreters may, for example, compile or translate source code into an intermediate representation (e.g., intermediate code, intermediate language, temporary form, etc.) and may execute the intermediate code; type 3 interpreters may execute stored precompiled code generated by a compiler that may, for example, be part of the interpreter. For example, languages such as Lisp, etc. may use a type 1 interpreter; languages such as Perl, Python, etc. may use a type 2 interpreter; languages such as Pascal, Java, etc. may use a type 3 interpreter. Some languages, such as Smalltalk, BASIC, etc. may, for example, combine facets, features, properties, etc. of interpreters of type 2 and interpreters of type 3. There may not always, for example, be a clear distinction between interpreters and compilers. For example, interpreters may also perform some translation. For example, some programming languages may be both compiled and interpreted or may include features of both. For example, a compiler may translate source code into an intermediate form (e.g., bytecode, portable code, p-code, intermediate code, etc.), that may then be passed to an interpreter. The terms interpreted language or compiled language applied to describing, classifying, etc. a programming language (e.g., C++ is a compiled programming language, etc.) may thus refer to an example (e.g., canonical, accepted, standard, theoretical, etc.) implementation of a programming language that may use an interpreter, compiler, etc. Thus a high-level computer programming language, for example, may be an abstract, ideal, theoretical, etc. representation that may be independent of a particular, specific, fixed, etc. implementation (e.g., independent of a compiled, interpreted version, etc.).

The devices (e.g., device software, device firmware, device applications, OSs, etc.) may use one or more alternative code forms, representations, etc. For example, a device may use bytecode that may be executed by an interpreter or that may be compiled. Bytecode may take any form. Bytecode, for example, may be based on (e.g., be similar to, use, etc.) hardware instructions and/or use hardware instructions in machine code. Bytecode design (e.g., format, architecture, syntax, appearance, semantics, etc.) may be based on a machine architecture (e.g., virtual stack machine, virtual register machine, etc.). Parts, portions, etc. of bytecode may be stored in files (e.g., modules, similar to object modules, etc.). Parts, portions, modules, etc. of bytecode may be dynamically loaded during execution. Intermediate code (e.g., bytecode, etc.) may be used to simplify and/or improve the performance, etc. of interpretation. Bytecode may be used, for example, in order to reduce hardware dependence, OS dependence, or other dependencies, etc. by allowing the same bytecode to run on different platforms (e.g., architectures, etc.). Bytecode may be directly executed on a VM (e.g., using an interpreter, etc.). Bytecode may be translated (e.g., compiled, etc.) to machine code, for example to improve performance, etc. Bytecode may include compact numeric codes, constants, references, numeric addresses, etc. that may encode the result of translation, parsing, semantic analysis, etc. of the types, scopes, nesting depths, etc. of program objects, constructs, structures, etc. The use of bytecode may, for example, allow improved performance over the direct interpretation of source code. Bytecode may be executed, for example, by parsing and executing bytecode instructions one instruction at a time. A bytecode interpreter may be portable (e.g., independent of device, machine architecture, computer system, computing platform, etc.).

The devices (e.g., device applications, OSs, etc.) may use one or more VMs. For example, a Java virtual machine (JVM) may use Java bytecode as intermediate code. Java bytecode may correspond, for example, to the instruction set of a stack-oriented architecture. For example, Oracle's JVM is called HotSpot. Examples of clean-room Java implementations may include Kaffe, IBM J9, and Dalvik. A software library (library) may be a collection of related object code. A class may be a unit of code. The Java Classloader may be part of the Java runtime environment (JRE) that may, for example, dynamically load Java classes into the JVM. Java libraries may be packaged in Jar files. Libraries may include objects of different types. One type of object in a Jar file may be a Java class. The class loader may locate libraries, read library contents, and load classes included within the libraries. Loading may, for example, be performed on demand, when the class is required by a program. Java may make use of external libraries (e.g., libraries written and provided by a third party, etc.). When a JVM is started, one or more of the following class loaders may be used: (1) bootstrap class loader; (2) extensions class loader; or (3) system class loader. The bootstrap class loader, which may be part of the core JVM, for example, may be written in native code and may load the core Java libraries. The extensions class loader may, for example, load code in the extensions directories. The system class loader may, for example, load code on the java.class.path stored in the system CLASSPATH variable. By default, all user classes may, for example, be loaded by the default system class loader that may be replaced by a user-defined ClassLoader. The Java class library may be a set of dynamically loadable libraries that Java applications may call at runtime. Because the Java platform may be independent of any OS, the Java platform may provide a set of standard class libraries that may, for example, include reusable functions commonly found in an OS. The Java class library may be almost entirely written in Java except, for example, for some parts that may need direct access to hardware, OS functions, etc. (e.g., for I/O, graphics, etc.). The Java classes that may provide access to these functions may, for example, use native interface wrappers, code fragments, etc. to access the API of the OS. Almost all of the Java class library may, for example, be stored in a Java archive file rt.jar, which may be provided with JRE and JDK distributions, for example.

The devices (e.g., device applications, OSs, etc.) may use one or more alternative code translation methods. For example, some code translation systems (e.g., dynamic translators, just-in-time compilers, etc.) may translate bytecode into machine language (e.g., native code, etc.) on demand, as required, etc. at runtime. Thus, for example, source code may be compiled and stored as machine independent code. The machine independent code may be linked at runtime and may, for example, be executed by an interpreter, compiler for JIT systems, etc. This type of translation, for example, may reduce portability, but may not reduce the portability of the bytecode itself. For example, programs may be stored in bytecode that may then be compiled using a JIT compiler that may translate bytecode to machine code. This may add a delay before a program runs and may, for example, improve execution speed relative to the direct interpretation of source code. Translation may, for example, be performed in one or more phases. For example, a first phase may compile source code to bytecode, and a second phase may translate the bytecode to a VM. There may be different VMs for different languages, representations, etc. (e.g., for Java, Python, PHP, Forth, Tcl, etc.). For example, Dalvik bytecode designed for the Android platform, for example, may be executed by the Dalvik VM. For example, the Dalvik VM may use special representations (e.g., DEX, etc.) for storing applications. For example, the Dalvik VM may use its own instruction set (e.g., based on a register-based architecture rather than stack-based architecture, etc.) rather than standard JVM bytecode, etc. Other implementations may be used. For example, the implementation of Perl, Ruby, etc. may use an abstract syntax tree (AST) representation that may be derived from the source code. For example, ActionScript (an object-oriented language that may be a superset of JavaScript, a scripting language) may execute in an ActionScript virtual machine (AVM) that may be part of Flash Player and Adobe Integrated Runtime (AIR). ActionScript code, for example, may be transformed into bytecode by a compiler. ActionScript compilers may be used, for example, in Adobe Flash Professional and in Adobe Flash Builder and may be available as part of the Adobe Flex SDK. A JVM may contain both and interpreter and JIT compiler and switch from interpretation to compilation for frequently executed code. One form of JIT compiler may, for example, represent a hybrid approach between interpreted and compiled code, and translation may occur continuously (e.g., as with interpreted code), but caching of translated code may be used e.g., to increase speed, performance, etc. JIT compilation may also offer advantages over static compiled code, e.g., the use late-bound data types, the ability to use and enforce security constraints, etc. JIT compilation may, for example, combine bytecode compilation and dynamic compilation. JIT compilation may, for example, convert code at runtime prior to executing it natively e.g., by converting bytecode into native machine code. Several runtime environments, (e.g., Microsoft .NET Framework, some implementations of Java, etc.) may, for example, use, employ, depend on, etc. JIT compilers. This specification may avoid the use of the term native machine code to avoid confusion with the terms machine code and native code.

The devices (e.g., device applications, OSs, etc.) may use one or more methods of emulation, simulation, etc. For example, binary translation may refer to the emulation of a first instruction set by a second instruction set (e.g., using code translation). For example, instructions may be translated from a source instruction set to a target instruction set. In some cases, such as instruction set simulation, the target instruction set may be the same as the source instruction set, and may, for example, provide testing features, debugging features, instruction trace, conditional breakpoints, hot spot detection, etc. Binary translation may be further divided into static binary translation and dynamic binary translation. Static binary translation may, for example, convert the code of an executable file to code that may run on a target architecture without, for example, having to run the code first. In dynamic binary translation, for example, the code may be run before conversion. In some cases conversion may not be direct since not all the code may be discoverable (e.g., reachable, etc.) by the translator. For example, parts of executable code may only be reached through indirect branches, with values, state, etc. needed for translation that may be known only at runtime. Dynamic binary translation may parse (e.g., process, read, etc.) a short sequence of code, may translate that code, and may cache the result of the translation. Other code may be translated as the code is discovered and/or when it is possible to be discovered. Branch instructions may point to already translated code and/or saved and/or cached (e.g., using memorization, etc.). Dynamic binary translation may differ from emulation and may eliminate the loop formed by the emulator reading, decoding, executing, etc. Binary translation may, for example, add a potential disadvantage of requiring additional translation overhead. The additional translation overhead may be reduced, ameliorated, etc. as translated code is repeated, executed multiple times, etc. For example, dynamic translators (e.g., Sun/Oracle HotSpot, etc.) may use dynamic recompilation, etc. to monitor translated code and aggressively (e.g., continuously, repeatedly, in an optimized fashion, etc.) optimize code that may be frequently executed, repeatedly executed, etc. This and other optimization techniques may be similar to that of a JIT compiler, and such compilers may be viewed as performing dynamic translation from a virtual instruction set (e.g., using bytecode, etc.) to a physical instruction set.

The term virtualization may refer to the creation (e.g., generation, design, etc.) of a virtual version (e.g., abstract version, apparent version, appearance of, illusion rather than actual, non-tangible object, etc.) of something (e.g., an object, tangible object, etc.) that may be real (e.g., tangible, non-abstract, physical, actual, etc.). For example, virtualization may apply to a device, mobile device, computer system, machine, server, hardware platform, platform, PC, tablet, operating system (OS), storage device, network resource, software, firmware, combinations of these and/or other objects, etc. For example, a VM may provide, present, etc. a virtual version of a real machine and may run (e.g., execute, etc.) a host OS, other software, etc. A VMM may be software (e.g., monitor, controller, supervisor, etc.) that may allow one or more VMs to run (e.g., be multiplexed, etc.) on one real machine. A hypervisor may be similar to a VMM. A hypervisor, for example, may be higher in functional hierarchy (e.g., logically, etc.) than a supervisor and may, for example, manage multiple supervisors (e.g., kernels, etc.). A domain (also logical domain, etc.) may run in (e.g., execute on, be loaded to, be joined with, etc.) a VM. The relationship between VMs and domains, for example, may be similar to that between programs and processes (or threads, etc.) in an OS. A VM may be a persistent (e.g., non-volatile, stored, permanent, etc.) entity that may reside (e.g., be stored, etc.) on disk and/or other storage, loaded into memory, etc. (e.g., and be analogous to a program, application, software, etc.). Each domain may have a domain identifier (also domain ID) that may be a unique identifier for a domain, and may be analogous (e.g., equivalent, etc.), for example, to a process ID in an OS. The term live migration may be a technique that may move a running (e.g., executing, live, operational, functional, etc.) VM to another physical host (e.g., machine, system, device, etc.) without stopping (e.g., halting, terminating, etc.) the VM and/or stopping any services, processes, threads, etc. that may be running on the VM.

Different types of hardware virtualization may include:
1. Full virtualization: Complete or almost complete simulation of actual hardware to allow software, which may comprise a guest operating system, to run unmodified. A VM may be (e.g., appear to be, etc.) identical (e.g., equivalent to, etc.) to the underlying hardware in full virtualization.
2. Partial virtualization: Some but not all of the target environment may be simulated. Some guest programs, therefore, may need modifications to run in this type of virtual environment.
3. Paravirtualization: A hardware environment is not necessarily simulated; however, the guest programs may be executed in their own isolated domains, as if they are running on a separate system. Guest programs may need to be specifically modified to run in this type of environment. A VM may differ (e.g., in appearance, in functionality, in behavior, etc.) from the underlying (e.g., native, real, etc.) hardware in paravirtualization.

There may be other differences between these different types of hardware virtualization environments. Full virtualization may not require modifications (e.g., changes, alterations, etc.) to the host OS and may abstract (e.g., virtualize, hide, obscure, etc.) underlying hardware. Paravirtualization may also require modifications to the host OS in order to run in a VM. In full virtualization, for example, privileged instructions and/or other system operations, etc. may be handled by the hypervisor with other instructions running on native hardware. In paravirtualization, for example, code may be modified e.g., at compile-time, runtime, etc. For example, in paravirtualization privileged instructions may be removed, modified, etc. and, for example, replaced with calls to a hypervisor e.g., using APIs, hypercalls, etc. For example, Xen may be an example of an OS that may use paravirtualization, but may preserve binary compatibility for user-space applications, etc.

Virtualization may be applied to an entire OS and/or parts of an OS. For example, a kernel may be a main (e.g., basic, essential, key, etc.) software component of an OS. A kernel may form a bridge (e.g., link, coupling, layer, conduit, etc.) between applications (e.g., software, programs, etc.) and underlying hardware, firmware, software, etc. A kernel may, for example, manage, control, etc. one or more (including all) system resources e.g., CPUs, processors, I/O devices, interrupt controllers, timers, etc. A kernel may, for example, provide a low-level abstraction layer for the system resources that applications may control, manage, etc. A kernel running, for example, at the highest hardware privilege level may make system resources available to user-space applications through inter-process communication (IPC) mechanisms, system calls, etc. A microkernel, for example, may be a smaller (e.g., smaller than a kernel, etc.) OS software component. In a microkernel the majority of the kernel code may be implemented, for example, in a set of kernel servers (also just servers) that may communicate through a small kernel, using a small amount of code running in system (e.g., kernel) space and the majority of code in user space. A microkernel may, for example, comprise a simple (e.g., relative to a kernel, etc.) abstraction over (e.g., logically above, etc.) underlying hardware, with a set of primitives, system calls, other code, etc. that may implement basic (e.g., minimal, key, etc.) OS services (e.g., memory management, multitasking, IPC, etc.). Other OS services, (e.g., networking, storage drivers, high-level functions, etc.) may be implemented, for example, in one or more kernel servers. An exokernel may, for example, be similar to a microkernel but may provide a more hardware-like interface e.g., more direct interface, etc. For example, an exokernel may be similar to a paravirtualizing VMM (e.g., Xen, etc.), but an exokernel may be designed as a distinct and separate OS structure rather than to run multiple conventional OSs. A nanokernel may, for example, delegate (e.g., assign, etc.) virtually all services (e.g., including interrupt controllers, timers, etc.), for example, to device drivers. The term operating system-level virtualization (also OS virtualization, container, virtual private server (VPS), virtual environment (VE), jail, etc.) may refer to a server virtualization technique. In OS virtualization, for example, the kernel of an OS may allow (e.g., permit, enable, implement, etc.) one or more isolated user-space instances or containers. For example, a container may appear to be a real server from the view of a user. For example, a container may be based on standard Linux chroot techniques. In addition to isolation, a kernel may control (e.g., limit, stop, regulate, manage, prevent, etc.) interaction between containers.

Virtualization may be applied to one or more hardware components. For example, VMs may include one or more virtual components. The hardware components and/or virtual components may be inside (e.g., included within, part of, etc.) or outside (e.g., connected to, external to, etc.) a CPU, and may be part of or include parts of a memory system and/or subsystem, or may be any part or parts of a system, device, or may be any combinations of such parts and the like, etc. A memory page (also virtual page, or just page) may, for example, be a contiguous block of virtual memory of fixed-length that may be the smallest unit used for (e.g., granularity of, etc.) memory allocation performed by the OS e.g., for a program, etc. A page table may be a data structure, hardware component, etc. used, for example, by a virtual memory system in an OS to store the mapping from virtual addresses to physical addresses. A memory management unit (MMU) may, for example, store a cache of memory mappings from the OS page table in a translation lookaside buffer (TLB). A shadow page table may be a component that is used, for example, by a technique to abstract memory layout from a VM OS. For example, one or more shadow page tables may be used in a VMM to provide an abstraction of (e.g., an appearance of, a view of, etc.) contiguous physical memory. A CPU may include one or more CPU components, circuit, blocks, etc. that may include one or more of the following, but not limited to the following: caches, TLBs, MMUs, page tables, etc. at one or more levels (e.g., L1, L2, L3, etc.). A CPU may include one or more shadow copies of one or more CPU components, etc. One or more shadow page tables may be used, for example, during live migration. One or more virtual devices may include one or more physical system hardware components (e.g., CPU, memory, I/O devices, etc.) that may be virtualized (e.g., abstracted, etc.) by, for example, a hypervisor and presented to one or more domains. In this description the term virtual device, for example, may also apply to virtualization of a device (and/or part(s), portion(s) of a device, etc.) such as a mobile phone or other mobile device, electronic system, appliance, etc. A virtual device may, for example, also apply to (e.g., correspond to, represent, be equivalent to, etc.) virtualization of a collection, set, group, etc. of devices and/or other hardware components, etc.

Virtualization may be applied to I/O hardware, one or more I/O devices (e.g., storage devices, cameras, graphics cards, input devices, printers, network interface cards, etc.), I/O device resources, etc. For example, an IOMMU may be a MMU that connects one or more I/O devices on one or more I/O buses to the memory system. The IOMMU may, for example, map (e.g., translate, etc.) I/O device virtual addresses (e.g., device addresses, I/O addresses, etc.) to physical addresses. The IOMMU may also include memory protection (e.g., preventing and/or controlling unauthorized access to I/O devices, I/O device resources, etc.), one or more memory protection tables, etc. The IOMMU may, for example, also allow (e.g., control, manage, etc.) direct memory access (DMA) and allow (e.g., enable, etc.) one or more VMs, etc. to access DMA hardware.

Virtualization may be applied to software (e.g., applications, programs, etc.). For example, the term application virtualization may refer to techniques that may provide one or more application features. For example, application virtualization may isolate (e.g., protect, separate, divide, insulate, etc.) applications from the underlying OS and/or from other applications. Application virtualization may, for example, enable (e.g., allow, permit, etc.) applications to be copied (e.g., streamed, transferred, pulled, pushed, sent, distributed, etc.) from a source (e.g., centralized location, control center, datacenter server, cloud server, home PC, manufacturer, distributor, licensor, etc.) to one or more target devices (e.g., user devices, mobile devices, clients, etc.). For example, application virtualization may allow (e.g., permit, enable, etc.) the creation of an isolated (e.g., a protected, a safe, an insulated, etc.) environment on a target device. A virtualized application may not necessarily be installed in a conventional (e.g., usual, normal, etc.) manner. For example, a virtualized application (e.g., files, configuration, settings, etc.) may be copied (e.g., streamed, distributed, etc.) to a target (e.g., destination, etc.) device rather than being installed, etc. The execution of a virtualized application at runtime may, for example, be controlled by an application virtualization layer. A virtualized application may, for example, appear to interface directly with the OS, but may actually interface with the virtualization environment. For example, the virtualization environment may proxy (e.g., intercept, forward, manage, control, etc.) one or more (including all) OS requests. The term application streaming may refer, for example, to virtualized application techniques that may use pieces (e.g., parts, portions, etc.) of one or more applications (e.g., code, data, settings, etc.) that may be copied (e.g., streamed, transferred, downloaded, uploaded, moved, pushed, pulled, etc.) to a target device. A software collection (e.g., set, distribution, distro, bundle, package, etc.) may, for example, be a set of software components built, assembled, configured, and ready for use, execution, installation, etc. Applications may be streamed, for example, as one or more collections. Application streaming may, for example, be performed on demand (e.g., as required, etc.) instead of copying or installing an entire application before startup. In some cases a streamed application may, for example, require the installation of a lightweight application on a target device. A streamed application and/or application collections may, for example, be delivered using one or more networking protocols (e.g., HTTP, HTTPS, CIFS, SMB, RTSP, etc.). The term desktop virtualization (also virtual desktop infrastructure (VDI), etc.) may refer, for example, to an application that may be hosted in a VM (or blade PC, appliance, etc.) and that may also include an OS. VDI techniques may, for example, include control of (e.g., management infrastructure for, automated creation of, etc.) one or more virtual desktops. The term session virtualization may refer, for example, to techniques that may use application streaming to deliver applications to one or more hosting servers (e.g., in a remote datacenter, cloud server, cloud service, etc.). The application may then, for example, execute on the hosting server(s). A user may then, for example, connect to (e.g., login, access, etc.) the application, hosting server(s), etc. The user and/or user device may, for example, send input (e.g., mouse-click, keystroke, mouse or other pointer location, audio, video, location, sensor data, control data, combinations of these and/or other data, information, user input, etc.) to the application e.g., on the hosting server(s), etc. The hosting server(s) may, for example, respond by sending output (e.g., screen updates, text, video, audio, signals, code, data, information, etc.) to the user device. A sandbox may, for example, isolate (e.g., insulate, separate, divide, etc.) one or more applications, programs, software, etc. For example, an OS may place an application (e.g., code, preferences, configuration, data, etc.) in a sandbox (e.g., at install time, at boot, or any time). A sandbox may, for example, include controls that may limit the application access (e.g., to files, preferences, network, hardware, firmware, other applications, etc.). As part of the sandbox process, technique, etc. an OS may, for example, install one or more applications in one or more separate sandbox directories (e.g., repositories, storage locations, etc.) that may store the application, application data, configuration data, settings, preferences, files, and/or other information, etc.

Devices may, for example, be protected from accidental faults (e.g., programming errors, bugs, data corruption, hardware faults, network faults, link faults, etc.) or malicious (e.g., deliberate, etc.) attacks (e.g., virus, malware, denial of service attacks, root kits, etc.) by various security, safety, protection mechanisms, etc. For example, CPUs, etc. may include one or more protection rings (or just rings, also hierarchical protection domains, domains, privilege levels, etc.). A protection ring may, for example, include one or more hierarchical levels (e.g., logical layers, etc.) of privilege (e.g., access rights, permissions, gating, etc.). For example, an OS may run (e.g., execute, operate, etc.) in a protection ring. Different protection rings may provide different levels of access (e.g., for programs, applications, etc.) to resources (e.g., hardware, memory, etc.). Rings may be arranged in a hierarchy ranging from the most privileged ring (e.g., most trusted ring, highest ring, inner ring, etc.) to the least privileged ring (e.g., least trusted ring, lowest ring, outer ring, etc.). For example, ring 0 may be a ring that may interact most directly with the real hardware (e.g., CPU, memory, I/O devices, etc.). For example, in a machine without virtualization, ring 0 may contain the OS, kernel, etc.; ring 1 and ring 2 may contain device drivers, etc.; ring 3 may contain user applications, programs, etc. For example, ring 1 may correspond to kernel space (e.g., kernel mode, master mode, supervisor mode, privileged mode, supervisor state, etc.). For example, ring 3 may correspond to user space (e.g., user mode, user state, slave mode, problem state, etc.). There is no fundamental restriction to the use of rings and, in general, any ring may correspond to any type of space, etc.

One or more gates (e.g., hardware gates, controls, call instructions, other hardware and/or software techniques, etc.) may be logically located (e.g., placed, situated, etc.) between rings to control (e.g., gate, secure, manage, etc.) communication, access, resources, transition, etc. between rings e.g., gate the access of an outer ring to resources of an inner ring, etc. For example, there may be gates or call instructions that may transfer control (e.g., may transition, exchange, etc.) to defined entry points in lower-level rings. For example, gating communication or transitions between rings may prevent programs in a first ring from misusing resources of programs in a second ring. For example, software running in ring 3 may be gated from controlling hardware that may only be controlled by device drivers running in ring 1. For example, software running in ring 3 may be required to request access to network resources that may be gated to software running in ring 1.

One or more coupled devices may form a collection, federation, confederation, assembly, set, group, cluster, etc. of devices. A collection of devices may perform operations, processing, computation, functions, etc. in a distributed fashion, manner, etc. In a collection etc. of devices that may perform distributed processing, it may be important to control the order of execution, how updates are made to files and/or databases, and/or other aspects of collective computation, etc. One or more models, frameworks, etc. may describe, define, etc. the use of operations, etc. and may use a set of definitions, rules, syntax, semantics, etc. using the concepts of transactions, tasks, composable tasks, noncomposable tasks, etc.

For example, a bank account transfer operation (e.g., a type of transaction, etc.) might be decomposed (e.g., broken, separated, etc.) into the following steps: withdraw funds from a first account one and deposit funds into a second account.

The transfer operation may be atomic. For example, if either step one fails or step two fails (or a computer crashes between step one and step two, etc.) the entire transfer operation should fail. There should be no possibility (e.g., state, etc.) that the funds are withdrawn from the first account but not deposited into the second account.

The transfer operation may be consistent. For example, after the transfer operation succeeds, any other subsequent transaction should see the results of the transfer operation.

The transfer operation may be isolated. For example, if another transaction tries to simultaneously perform an operation on either the first or second accounts, what they do to those accounts should not affect the outcome of the transfer option.

The transfer operation may be durable. For example, after the transfer operation succeeds, if a computer should fail, etc., there may be a record that the transfer took place.

The terms tasks, transactions, composable, noncomposable, etc. may have different meanings in different contexts (e.g., with different uses, in different applications, etc.). One set of frameworks (e.g., systems, applications, etc.) that may be used, for example, for transaction processing, database processing, etc. may be languages (e.g., computer languages, programming languages, etc.) such as structured transaction definition language (STDL), structured query language (SQL), etc.

For example, a transaction may be a set of operations, actions, etc. to files, databases, etc. that must take place as a set, group, etc. For example, operations may include read, write, add, delete, etc. All the operations in the set must complete or all operations may be reversed. Reversing the effects of a set of operations may roll back the transaction. If the transaction completes, the transaction may be committed. After a transaction is committed, the results of the set of operations may be available to other transactions.

For example, a task may be a procedure that may control execution flow, delimit or demarcate transactions, handle exceptions, and may call procedures to perform, for example, processing functions, computation, access files, access databases (e.g., processing procedures) or obtain input, provide output (e.g., presentation procedures).

For example, a composable task may execute within a transaction. For example, a noncomposable task may demarcate (e.g., delimit, set the boundaries for, etc.) the beginning and end of a transaction. A composable task may execute within a transaction started by a noncomposable task. Therefore, the composable task may always be part of another task's work. Calling a composable task may be similar to calling a processing procedure, e.g., based on a call and return model. Execution of the calling task may continue only when the called task completes. Control may pass to the called task (possibly with parameters, etc.) and then control may return to the calling task. The composable task may always be part of another task's transaction. A noncomposable task may call a composable task and both tasks may be located on different devices. In this case, their transaction may be a distributed transaction. There may be no logical distinction between a distributed and nondistributed transaction.

Transactions may compose. For example, the process of composition may take separate transactions and add them together to create a larger single transaction. A composable system, for example, may be a system whose component parts do not interfere with each other.

For example, a distributed car reservation system may access remote databases by calling composable tasks in remote task servers. For example, a reservation task at a rental site may call a task at the central site to store customer data in the central site rental database. The reservation task may call another task at the central site to store reservation data in the central site rental database and the history database.

The use of composable tasks may enable a library of common functions to be implemented as tasks. For example, applications may require similar processing steps, operations, etc. to be performed at multiple stages, points, etc. For example, applications may require one or more tasks to perform the same processing function. Using a library, for example, common functions may be called from multiple points within a task or from different tasks.

A uniform resource locator (URL) is a uniform resource identifier (URI) that specifies where a known resource is available and the mechanism for retrieving it. A URL comprises the following: the scheme name (also called protocol, e.g., http, https, etc.), a colon (“:”), a domain name (or IP address), a port number, and the path of the resource to be fetched. The syntax of a URL is scheme://domain:port/path.

HTTP is the hypertext transfer protocol.

HTTPS is the hypertext transfer protocol secure (HTTPS) and is a combination of the HTTP with the SSL/TLS protocol to provide encrypted communication and secure identification.

A session is a sequence of network request-response transactions.

An IP address is a binary number assigned to a device on an IP network (e.g., 172.16.254.1) and can be formatted as a 32-bit dot-decimal notation (e.g., for IPv4) or in a notation to represent 128-bits, such as “2001:db8:0:1234:0:567:8:1” (e.g., for IPv6).

A domain name comprises one or more concatenated labels delimited by dots (periods), e.g., “en.wikipedia.org”. The domain name “en.wikipedia.org” includes labels “en” (the leaf domain), “wikipedia” (the second-level domain), and “org” (the top-level domain).

A hostname is a domain name that has at least one IP address. A hostname is used to identify a device (e.g., in an IP network, on the World Wide Web, in an e-mail header, etc.). Note that all hostnames are domain names, but not all domain names are hostnames. For example, both en.wikipedia.org and wikipedia.org are hostnames if they both have IP addresses assigned to them. The domain name xyz.wikipedia.org is not a hostname if it does not have an IP address, but aa.xyz.wikipedia.org is a hostname if it does have an IP address.

A domain name comprises one or more parts, the labels that are concatenated, being delimited by dots such as “example.com”. Such a concatenated domain name represents a hierarchy. The right-most label conveys the top-level domain; for example, the domain name www.example.com belongs to the top-level domain com. The hierarchy of domains descends from the right to the left label in the name; each label to the left specifies a subdivision, or subdomain of the domain to the right. For example, the label example specifies a node example.com as a subdomain of the corn domain, and www is a label to create www.example.com, a subdomain of example.com.

The DHCP is the dynamic host configuration protocol (described in RFC 1531 and RFC 2131) and is an automatic configuration protocol for IP networks. When a DHCP-configured device (DHCP client) connects to a network, the DHCP client sends a broadcast query requesting an IP address from a DHCP server that maintains a pool of IP addresses. The DHCP server assigns the DHCP client an IP address and lease (the length of time the IP address is valid).

A media access control address (MAC address, also Ethernet hardware address (EHA), hardware address, physical address) is a unique identifier (e.g., 00-B0-D0-86-BB-F7) assigned to a network interface (e.g., address of a network interface card (NIC), etc.) for communications on a physical network (e.g., Ethernet).

A trusted path (and thus trusted user, and/or trusted device, etc.) is a mechanism that provides confidence that a user is communicating with what the user intended to communicate with, ensuring that attackers cannot intercept or modify the information being communicated.

A proxy server (also proxy) is a server that acts as an intermediary (e.g., gateway, go-between, helper, relay, etc.) for requests from clients seeking resources from other servers. A client connects to the proxy server, requesting a service (e.g., file, connection, web page, or other resource, etc.) available from a different server, the origin server. The proxy server provides the resource by connecting to the origin server and requesting the service on behalf of the client. A proxy server may alter the client request or the server response.

A forward proxy located in an internal network receives requests from users inside an internal network and forwards the requests to the Internet outside the internal network. A forward proxy typically acts a gateway for a client browser (e.g., user, client, etc.) on an internal network and sends HTTP requests on behalf of the client browser to the Internet. The forward proxy protects the internal network by hiding the client IP address by using the forward proxy IP address. The external HTTP server on the Internet sees requests originating from the forward proxy rather than the client.

A reverse proxy (also origin-side proxy, server-side proxy) located in an internal network receives requests from Internet users outside the internal network and forwards the requests to origin servers in the internal network. Users connect to the reverse proxy and may not be aware of the internal network. A reverse proxy on an internal network typically acts as a gateway to an HTTP server on the internal network by acting as the final IP address for requests from clients that are outside the internal network. A firewall is typically used with the reverse proxy to ensure that only the reverse proxy can access the HTTP servers behind the reverse proxy. The external client sees the reverse proxy as the HTTP server.

An open proxy forwards requests to and from anywhere on the Internet.

In network computing, the term demilitarized zone (DMZ, also perimeter network), is used to describe a network (e.g., physical network, logical subnetwork, etc.) exposed to a larger untrusted network (e.g., Internet, cloud, etc.). A DMZ may, for example, expose external services (e.g., of an organization, company, device, etc.). One function of a DMZ is to add an additional layer of security to a local area network (LAN). In the event of an external attack, the attacker only has access to resources (e.g., equipment, server(s), router(s), etc.) in the DMZ.

In the HTTP protocol a redirect is a response (containing header, status code, message body, etc.) to a request (e.g., GET, etc.) that directs a client (e.g., browser, etc.) to go to another location (e.g., site, URL, etc.)

A localhost (as described, for example, in RFC 2606) is the hostname given to the address of the loopback interface (also virtual loopback interface, loopback network interface, loopback device, network loopback), referring to “this computer”. For example, directing a browser on a computer running an HTTP server to a loopback address (e.g., http://localhost, http://127.0.0.1, etc.) may display the website of the computer (assuming a web server is running on the computer and is properly configured). Using a loopback address allows connection to any locally hosted network service (e.g., computer game server, or other inter-process communications, etc.).

The localhost hostname corresponds to an IPv4 address in the 127.0.0.0/8 net block i.e., 127.0.0.1 (for IPv4, see RFC 3330) or ::1 (for IPv6, see RFC 3513). The most common IP address for the loopback interface is 127.0.0.1 for IPv4, but any address in the range 127.0.0.0 to 127.255.255.255 maps to the loopback device. The routing table of an operating system (OS) may contain an entry so that traffic (e.g., packet, network traffic, IP datagram, etc.) with destination IP address set to a loopback address (the loopback destination address) is routed internally to the loopback interface. In the TCP/IP stack of an OS the loopback interface is typically contained in software (and not connected to any network hardware).

An Internet socket (also network socket or just socket) is an endpoint of a bidirectional inter-process communication (IPC) flow across a network (e.g., IP-based computer network such as the Internet, etc.). The term socket is also used for the API for the TCP/IP protocol stack. Sockets provide the mechanism to deliver incoming data packets to a process (e.g., application, program, application process, thread, etc.), based on a combination of local (also source) IP address, local port number, remote (also destination) IP address, and remote port number. Each socket is mapped by the OS to a process. A socket address is the combination of an IP address and a port number.

Communication between server and client (which are types of endpoints) may use a socket. Communicating local and remote sockets are socket pairs. A socket pair is described by a unique 4-tuple (e.g., four numbers, four sets of numbers, etc.) of source IP address, destination IP address, source port number, destination port number, (e.g., local and remote socket addresses). For TCP, each socket pair is assigned a unique socket number. For UDP, each local socket address is assigned a unique socket number.

A computer program may be described using one or more function calls (e.g., macros, subroutines, routines, processes, etc.) written as function_name ( ) where function_name is the name of the function. The process (e.g., a computer program, etc.) by which a local server establishes a TCP socket may include (but is not limited to) the following steps and functions:
1. socket ( ) creates a new local socket.
2. bind ( ) associates (e.g., binds, links, ties, etc.) the local socket with a local socket address i.e., a local port number and IP address (the socket and port are thus bound to a software application running on the server).
3. listen ( ) causes a bound local socket to enter the listen state.

A remote client then establishes connections with the following steps:
1. socket ( ) creates a new remote socket.
2. connect ( ) assigns a free local port number to the remote socket and attempts to establishes a new connection with the local server.

The local server then establishes the new connection with the following step:
1. accept ( ) accepts the request to create a new connection from the remote client.

Client and server may now communicate using send ( ) and receive ( ).

An abstraction of the architecture of the World Wide Web is representational state transfer (REST). The REST architectural style was developed by the W3C Technical Architecture Group (TAG) in parallel with HTTP 1.1, based on the existing design of HTTP 1.0 The World Wide Web represents the largest implementation of a system conforming to the REST architectural style. A REST architectural style may consist of a set of constraints applied to components, connectors, and data elements, e.g., within a distributed hypermedia system. REST ignores the details of component implementation and protocol syntax in order to focus on the roles of components, the constraints upon their interaction with other components, and their interpretation of significant data elements. REST may be used to describe desired web architecture, to identify existing problems, to compare alternative solutions, and to ensure that protocol extensions do not violate the core constraints of the web. The REST architectural style may also be applied to the development of web services as an alternative to other distributed-computing specifications such as SOAP.

The REST architectural style describes six constraints: (1) Uniform Interface. The uniform interface constraint defines the interface between clients and servers. It simplifies and decouples the architecture, which enables each part to evolve independently. The uniform interface that any REST services must provide is fundamental to its design. The four principles of the uniform interface are: (1.1) Resource-Based. Individual resources are identified in requests using URIs as resource identifiers. The resources themselves are conceptually separate from the representations that are returned to the client. For example, the server does not send its database, but rather, some HTML, XML or JSON that represents some database records expressed, for instance, in Finnish and encoded in UTF-8, depending on the details of the request and the server implementation.

### Manipulation of Resources Through Representations.

When a client holds a representation of a resource, including any metadata attached, it has enough information to modify or delete the resource on the server, provided it has permission to do so. (1.3) Self-descriptive Messages. Each message includes enough information to describe how to process the message. For example, which parser to invoke may be specified by an Internet media type (previously known as a MIME type). Responses also explicitly indicate their cache-ability. (1.4) Hypermedia as the Engine of Application State (HATEOAS). Clients deliver state via body contents, query-string parameters, request headers and the requested URI (the resource name). Services deliver state to clients via body content, response codes, and response headers. This is technically referred to as hypermedia (or hyperlinks within hypertext). HATEOAS also means that, where necessary, links are contained in the returned body (or headers) to supply the URI for retrieval of the object itself or related objects. (2) Stateless. The necessary state to handle the request is contained within the request itself, whether as part of the URI, query-string parameters, body, or headers. The URI uniquely identifies the resource and the body contains the state (or state change) of that resource. Then, after the server completes processing, the appropriate state, or the piece(s) of state that matter, are communicated back to the client via headers, status and response body. A container provides the concept of “session” that maintains state across multiple HTTP requests. In REST, the client must include all information for the server to fulfill the request, resending state as necessary if that state must span multiple requests. Statelessness enables greater scalability since the server does not have to maintain, update, or communicate that session state. Additionally, load balancers do not have to deal with session affinity for stateless systems. State, or application state, is that which the server cares about to fulfill a request—data necessary for the current session or request. A resource, or resource state, is the data that defines the resource representation—the data stored in the database, for instance. Application state may be data that could vary by client, and per request. Resource state, on the other hand, is constant across every client who requests it. (3) Cacheable. Clients may cache responses. Responses must therefore, implicitly or explicitly, define themselves as cacheable, or not, to prevent clients reusing stale or inappropriate data in response to further requests. Well-managed caching partially or completely eliminates some client-server interactions, further improving scalability and performance. (4) Client-Server. The uniform interface separates clients from servers. This separation of concerns means that, for example, clients are not concerned with data storage, which remains internal to each server, so that the portability of client code is improved. Servers are not concerned with the user interface or user state, so that servers can be simpler and more scalable. Servers and clients may also be replaced and developed independently, as long as the interface is not altered. (5) Layered System. A client cannot ordinarily tell whether it is connected directly to the end server, or to an intermediary along the way. Intermediary servers may improve system scalability by enabling load-balancing and by providing shared caches. Layers may also enforce security policies. (6) Code on Demand (optional). Servers are able to temporarily extend or customize the functionality of a client by transferring logic to the client that it can then execute. Examples of this may include compiled components such as Java applets and client-side scripts such as JavaScript. Complying with these constraints, and thus conforming to the REST architectural style, will enable any kind of distributed hypermedia system to have desirable emergent properties such as performance, scalability, simplicity, modifiability, visibility, portability and reliability. The only optional constraint of REST architecture is code on demand. If a service violates any other constraint, it cannot strictly be referred to as RESTful.

In computer programming, an application programming interface (API) specifies how software components should interact with each other. In addition to accessing databases or computer hardware such as hard disk drives or video cards, an API may be used to simplify the programming of graphical user interface components. An API may be provided in the form of a library that includes specifications for routines, data structures, object classes, and variables. In other cases, notably for SOAP and REST services, an API may be provided as a specification of remote calls exposed to the API consumers. An API specification may take many forms, including an international standard such as POSIX, vendor documentation such as the Microsoft Windows API, or the libraries of a programming language, e.g., Standard Template Library in C++ or Java API. Web APIs may also be a component of the web fabric. An API may differ from an application binary interface (ABI) in that an API may be source code based while an ABI may be a binary interface. For instance POSIX may be an API, while the Linux standard base may be an ABI.

### Overview

Some embodiments of the present disclosure address the problem of cost-effectively scaling the communications with an increasing number of devices connected to the Internet and some embodiments are directed to approaches for using multiple device connection URLs to enable DNS load balancing for redundancy and scalability. More particularly, disclosed herein and in the accompanying figures are exemplary environments, methods, and systems for using multiple connection URLs to enable load balanced inter-device messaging.

As increasingly more devices (e.g., servers, computers, phones, equipment, cameras, appliances, etc.) are connected to the Internet, the need to connect them in a meaningful, fast, secure, and cost-effective way becomes increasingly difficult. Specific scalability challenges related to managing the messaging between devices are evident. More specifically, the loading of the servers processing the messaging can be unbalanced if not managed. The present disclosure addresses this problem by providing connection and messaging systems and services that balance the loading on the notification servers in the system. The notification devices have access to multiple servers, from which the notification service will select (e.g., to optimize load balancing), while the listener devices have a single notification interface to which they connect to receive messages. The approaches provided by the present disclosure provides redundancy, scalability, and other benefits.

### Conventions and Use of Terms

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. The articles “a” and “an” as used in this application and the appended claims should generally be construed to mean “one or more” unless specified otherwise or is clear from the context to be directed to a singular form.

If any definitions (e.g., figure reference signs, specialized terms, examples, data, information, definitions, conventions, glossary, etc.) from any related material (e.g., parent application, other related application, material incorporated by reference, material cited, extrinsic reference, etc.) conflict with this application (e.g., abstract, description, summary, claims, etc.) for any purpose (e.g., prosecution, claim support, claim interpretation, claim construction, etc.), then the definitions in this application shall apply.

This section may include terms and definitions that may be applicable to all embodiments described in this specification and/or described in specifications incorporated by reference. Terms that may be special to the field of the various embodiments of the disclosure or specific to this description may, in some circumstances, be defined in this description. Further, the first use of such terms (which may include the definition of that term) may be highlighted in italics just for the convenience of the reader. Similarly, some terms may be capitalized, again just for the convenience of the reader. It should be noted that such use of italics and/or capitalization and/or use of other conventions, styles, formats, etc. by itself, should not be construed as somehow limiting such terms beyond any given definition and/or to any specific embodiments disclosed herein, etc.

### Use of Equivalents

The terminology used herein is for the purpose of describing particular embodiments only and is not intended to be limiting of the invention. As used herein, the singular forms (e.g., a, an, the, etc.) are intended to include the plural forms as well, unless the context clearly indicates otherwise.

The terms comprises and/or comprising, when used in this specification, specify the presence of stated features, integers, steps, operations, elements, and/or components, but do not preclude the presence or addition of one or more other features, integers, steps, operations, elements, components, and/or groups thereof.

In the following description and claims, the terms include and comprise, along with their derivatives, may be used, and are intended to be treated as synonyms for each other.

In the following description and claims, the terms coupled and connected, along with their derivatives, may be used. It should be understood that these terms are not necessarily intended as synonyms for each other. For example, connected may be used to indicate that two or more elements (e.g., circuits, components, logical blocks, hardware, software, firmware, processes, computer programs, etc.) are in direct physical, logical, and/or electrical contact with each other. Further, coupled may be used to indicate that that two or more elements are in direct or indirect physical, electrical and/or logical contact. For example, coupled may be used to indicate that that two or more elements are not in direct contact with each other, but the two or more elements still cooperate or interact with each other.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The terms that are explained, described, defined, etc. here and other related terms in the fields of systems design may have different meanings depending, for example, on their use, context, etc. For example, task may carry a generic or general meaning encompassing, for example, the notion of work to be done, etc. or may have a very specific meaning particular to a computer language construct (e.g., in STDL or similar). For example, the term transaction may be used in a very general sense or as a very specific term in a computer program or computer language, etc. Where confusion may arise over these and other related terms, further clarification may be given at their point of use herein.

Reference is now made in detail to certain embodiments. The disclosed embodiments are not intended to be limiting of the claims.

### DESCRIPTIONS OF EXEMPLARY EMBODIMENTS

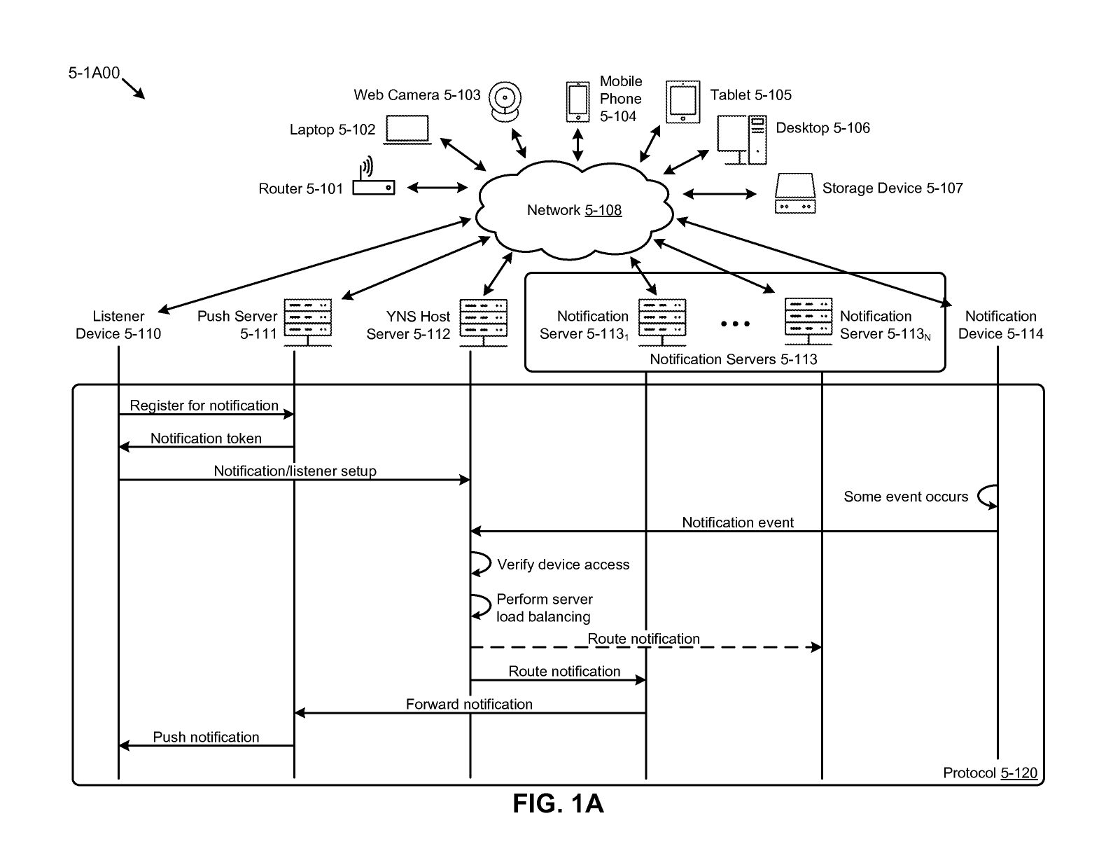

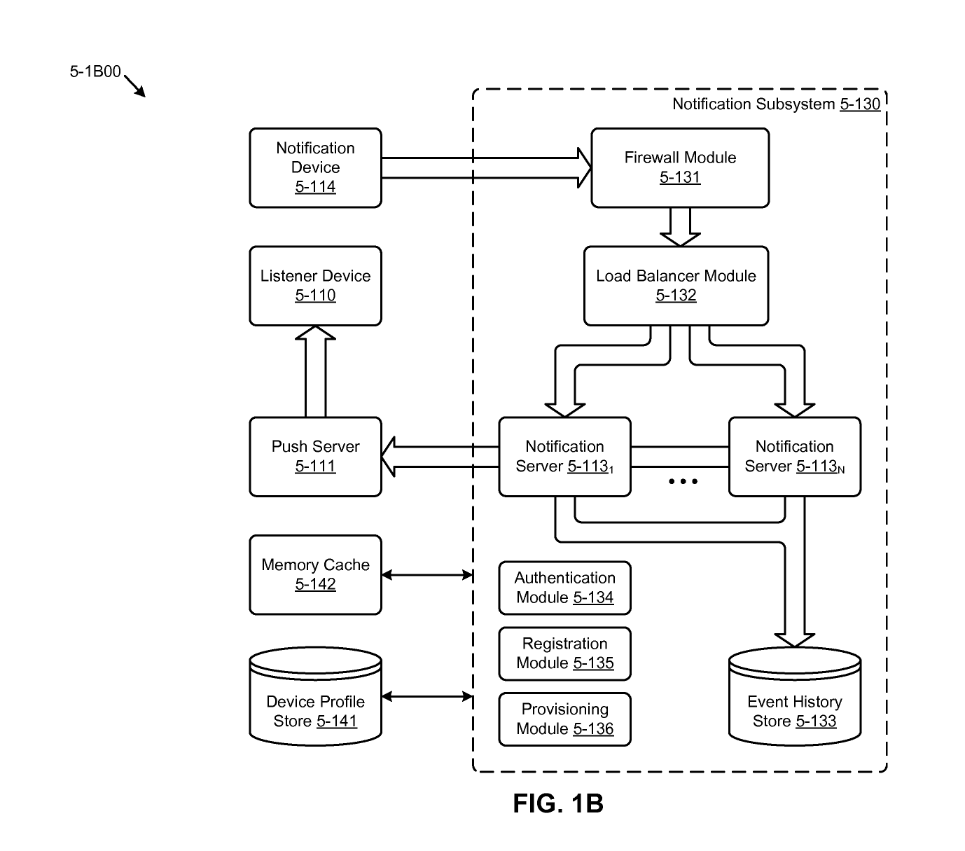

FIG. 1A is an environment 5-1A00 that supports using multiple connection URLs to enable load balanced inter-device messaging, according to one embodiment. As an option, one or more instances of environment 5-1A00 or any aspect thereof may be implemented in the context of the architecture and functionality of various embodiments described herein. Also, environment 5-1A00 or any aspect thereof may be implemented in any desired environment.

The environment 5-1A00 comprises the aspects shown. This exemplary embodiment as well as other embodiments may implement additional features. Environment 5-1A00 comprises various computing systems interconnected by a network 5-108. Network 5-108 can comprise any combination of a wide area network (WAN), local area network (LAN), wireless network, wireless LAN (WLAN), or any similar means for enabling communication of computing systems. Network 5-108 can also collectively be referred to as the Internet. Environment 5-1A00 comprises a representative instance of a push server 5-111, a representative Yoics notification service (e.g., implemented on a YNS host server 5-112), a plurality of notification servers 5-113 (e.g., notification server 2-113ₖ, notification server 2-113_{N}), a representative instance of a listener device 5-110, a representative notification device 5-114, and a representative variety of types and instances of listener device 5-110 and notification device 5-114 (e.g., a router 5-101, a laptop 5-102, a web camera 5-103, a mobile phone 5-104, a tablet 5-105, a desktop 5-106, and a storage device 5-107). Listener device 5-110 and notification device 5-114 can represent any type of device as described in this disclosure. A protocol 5-120 depicts operations and communications on and among listener device 5-110, push server 5-111, YNS host server 5-112, the plurality of notification servers 5-113, and notification device 5-114. Protocol 5-120 represents the key activities in a system that supports using multiple connection URLs to enable load balanced (e.g., between the plurality of notification servers 5-113) inter-device messaging, in one embodiment.

More specifically, in the example of protocol 5-120, notification device 5-110 can be any device (e.g., web camera 5-103, etc.) enabled with embedded notification services. Further, listener device 5-110 can be any device (e.g., mobile handset, mobile phone 5-104, tablet 5-105, etc.) hosting a client application (e.g., “app”) that is listening (e.g., has notification turned on) to one or more notification devices and receiving push notifications, wherein the client application can be a third-party application using the YNS APIs, and the push notifications can be asynchronous messages. More specifically, push notifications can include an “in-app” notification received by the app when it is running, and an “out-app” notification received and displayed by listener device 5-110 when the app is not running.

Specifically, protocol 5-120 and environment 5-1A00 support a notification service (NS) that provides enabled products (e.g., notification device 5-114) with generic methods to communicate notifications (e.g., events and alarms) with the product's registered owner (e.g., user of listener device 5-110) over mobile notification or push systems (e.g., through push server 5-111), such as the Apple Push Notification Service (APNS), the Google Cloud Messaging (GCM), or JPush platforms. These notifications can be application specific (e.g., supporting network cameras with motion and audio alarm capabilities). As shown in protocol 5-120, YNS usage can begin with listener device 5-110 registering for notification (e.g., can be off by default) with a push server at push server 5-111 (e.g., APNS for iOS handsets, or GCM or JPush for Android handsets). Push server 5-111 then provides a notification token back to listener device 5-110 to allow listener device 5-110 to be setup for notifications and listening (e.g., to specifically enabled notification devices) with the YNS at YNS host server 5-112. This step can be done, for example, in conjunction with registering a remote storage solution for storing recorded video (e.g., YouTube), since the YNS may not store all event data. Also, the client app API can use a common load balanced URL (e.g., notification.yoics.net) to access the YNS APIs. When some event occurs on notification device 5-114, the notification event (e.g., a single message from a notification device) will be communicated with the YNS at YNS host server 5-112. In some embodiments, notification device 5-114 can use multiple primary base URLs (e.g., notify1.yoics.net, notify2.yoics.net, notify3.yoics.net, notify4.yoics.net, etc.) to contact the NS, wherein the server at each URL contains the same APIs and capabilities. In some embodiments, these URLs can be used (e.g., by a standard UpTube notification engine or daemon) in a random access pattern. YNS host server 5-112 will first verify access for notification device 5-114 (e.g., as a firewall) and then prepare to route the message by performing a server load balancing analysis. YNS host server 5-112 can choose to route the notification message to any of the plurality of notification servers 5-113 to optimize the load balancing of the servers. As shown in protocol 5-120, YNS host server 5-112 routes the notification to notification server 5-113₁, which forwards the notification to the push service (e.g., back-end service such as APNS, GCM, or JPush) at push server 5-111. In the final step, push server 5-111 delivers the push notification from notification device 5-114 to listener device 5-110. In some embodiments, the push notification can be an SMTP notification (e.g., an email message sent to the registered user's email address).

The operational and communication flow through a representative YNS system is shown in the following diagram.

FIG. 1B is a block diagram depicting a system 5-1B00 for using multiple connection URLs to enable load balanced inter-device messaging, in one embodiment. As an option, one or more instances of system 5-1B00 or any aspect thereof may be implemented in the context of the architecture and functionality of various embodiments described herein. Also, system 5-1B00 or any aspect thereof may be implemented in any desired environment.

As shown in FIG. 1B, system 5-1B00 comprises a notification subsystem 5-130 in communication with listener device 5-110, push server 5-111, and notification device 5-114 from environment 5-1A00. A device profile store 5-141 and a memory cache 5-142 are also included in system 5-1B00. Notification subsystem 5-130 further comprises a firewall module 5-131, a load balancer module 5-132, the plurality of notification servers 5-113 from environment 5-1A00, an event history store 5-133, an authentication module 5-134, a registration module 5-135, and a provisioning module 5-136. This exemplary embodiment as well as other embodiments may implement additional features. The flow of systems 5-1B00 starts with notification device 5-114 sending a notification message to notification subsystem 5-130 through firewall module 5-131. Firewall module 5-131 validates access for notification device 5-114 and validates the message before sending it on to load balancer module 5-132 for determining the optimized routing of the message for balancing the load on the plurality of notification servers 5-113. The notification message then gets sent to notification subsystem 5-130, then to push server 5-111, and then on to listener device 5-110. Other modules and components shown in system 5-1B00 that support various functions are memory cache 5-142 and device profile store 5-141 (e.g., access to list of notification devices, device profile information, etc.); authentication module 5-134 (e.g., user login credential verification, etc.); registration module 5-135 (e.g., device and listener registration processing, etc.); and provisioning module 5-136 (e.g., cloud storage setup and provisioning, etc.).

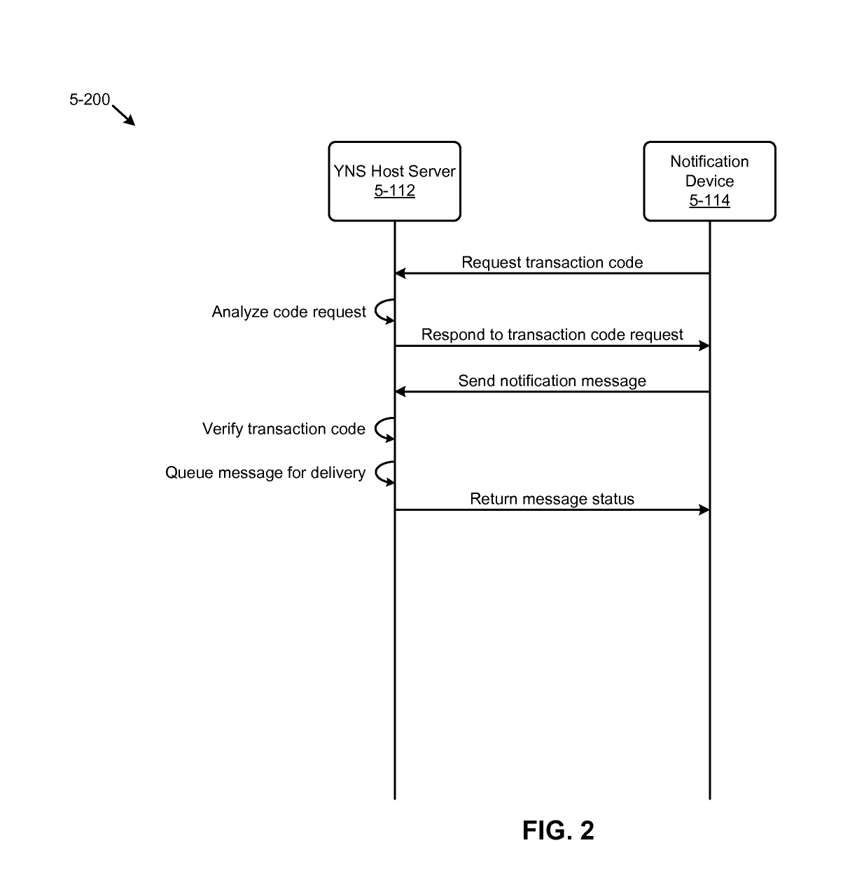

FIG. 2 is a diagram showing a notification device protocol 5-200 for use in systems that use multiple connection URLs to enable load balanced inter-device messaging, in one embodiment. As an option, one or more instances of notification device protocol 5-200 or any aspect thereof may be implemented in the context of the architecture and functionality of various embodiments described herein. Also, notification device protocol 5-200 or any aspect thereof may be implemented in any desired environment.

The notification device protocol 5-200 comprises the aspects shown. This exemplary embodiment as well as other embodiments may implement additional features. Notification device protocol 5-200 depicts operations and communications on and among YNS host server 5-112 and notification device 5-114 from environment 5-1A00. Specifically, notification device protocol 5-200 shows that notification device 5-114 must request a transaction code from the YNS before notifications can be sent. In some embodiments, a transaction code can be an authorization string provided by the NS, allowing a notification device to send notification messages to the NS. The YNS may reject the request for the transaction code under certain conditions (e.g., related to send rate and correct message formatting). All transactions to send a notification must include a valid and active (e.g., not expired) transaction code. The transaction code can be an alpha numeric code that is of a minimum length (e.g., 16 characters). The client may also need to provide the device UID as a parameter for the transaction code request. Table 1 is an example of the transaction code request (e.g., call) format. The server and path information can be controlled by templates in a configuration file.

TABLE 1

| Ref | Information |
|---|---|
| 1 | http://<server>/request_code.php?uid=<uid>&type=<respformat> |
| 2 | where, |
| 3 | <server> is the server name (e.g., notify1.yoics.com) |
| 4 | <uid> is the formatted (e.g., with colons) device id for the device |
| 5 | <respformat> is “json” or “xml” designating the response format |

The YNS at YNS host server 5-112 will then analyze the transaction code request. The response to the transaction code request can either be in “json” format or in “xml” format depending on the “type” parameter. The default can be “json” if no format is provided. For example, if the response format is “j son” and the operation succeeds the response will be as shown in Table 2.

TABLE 2

| Ref | Information |
|---|---|
| 1 | {“NewDataSet”: |
| | { “Table”: [ {“status”: “ok”, “code”:”<code>”}] }} |

If the response format is “json” and an error occurs the response will be as shown in Table 3.

TABLE 3

| Ref | Information |
|---|---|
| 1 | { “NewDataSet”: { “Table”: [ {“status”: “error”, |
| | “error”:”<errorcode>”, “errorid”:”<errorid>”, |
| | “message”:”<errormessage>”}] }} |

If the format is “xml” and the operation succeeds the response will be as shown in Table 4.

TABLE 4

| Ref | Information |
|---|---|
| 1 | <NewDataSet> |
| 2 | <Table> |
| 3 | <status>ok</status> |
| 4 | <code>code</code> |
| 5 | </Table> |
| 6 | </NewDataSet> |

If the response format is “xml” and an error occurs the response will be as shown in Table 5.

TABLE 5

| Ref | Information |
|---|---|
| 1 | <NewDataSet> |
| 2 | <Table> |
| 3 | <status>error</status> |
| 4 | <errorcode>errorcode</errorcode> |
| 5 | <errorid>errorid</errorid> |
| 6 | <message>errormsg</message> |
| 7 | </Table> |
| 8 | </NewDataSet> |

After notification device 5-114 receives the transaction code, a notification message or request may be sent to the YNS at YNS host server 5-112. If the transaction code is valid, the YNS will queue the message for delivery and return a successful status to notification device 5-114. Notification device 5-114 may not wait or be informed of the actual delivery status of the notification message. Table 6 is an example of the notification request (e.g., call) format. The server and path information can be controlled by templates in a configuration file.

TABLE 6

| Ref | Information |
|---|---|
| 1 | http://<server>/send_notification.php?transaction_code= |
| | <transactioncode>&uid=<uid>&device_type= |
| | <devicetype>&event_type=<eventtype>&timestamp= |
| | <timestamp>&message=<message>&status= |
| | <status>&transaction_hash= |
| | <transactionhash>&type=<respformat> |
| 2 | where, |
| 3 | <server> is the server name (e.g., notify1.yoics.com), |
| 4 | <transaction_code> is a valid transaction code acquired from the |
| | server |
| 5 | <uid> is the formatted (e.g., with colons) device id for the device |
| 6 | <device_type> unique device type stored in the configuration file |
| 7 | <event_type> event type (e.g., audio, video, status, etc.) |
| 8 | <timestamp> timestamp for the event using the format |
| | “%Y%m%d%H%M%S” |
| 9 | <message> base64 encoded message string |
| 10 | <status> base64 encoded status string |
| 11 | <transactionhash> hash field from template in configuration file |
| 12 | <respformat> is “json” or “xml” designating the response format |

The notification message response will either be in “json” format or in “xml” format depending on the “type” parameter. The default can be “json” if no format is provided. If the response format is “json” and the operation succeeds the response will be as shown in Table 7.

TABLE 7

| Ref | Information |
|---|---|
| 1 | { “NewDataSet”: { “TABLE”: [ {“status”: “ok”}] }} |

If the response format is “json” and an error occurs the response will be as shown in Table 8.

TABLE 8

| Ref | Information |
|---|---|
| 1 | { “NewDataSet”: {“TABLE”: [ {“status”: “error”, |
| | “error”:”<errorcode>”, “errorid”:”<errorid>”, |
| | “message”:”<errormessage>”}] }} |

If the format is “xml” and operation succeeds the response will be as shown in Table 9.

TABLE 9

| Ref | Information |
|---|---|
| 1 | <NewDataSet> |
| 2 | <TABLE> |
| 3 | <status>ok</status> |
| 4 | </TABLE> |
| 5 | </NewDataSet> |

If the response format is “xml” and an error occurs the response will be as shown in Table 10.

TABLE 10

| Ref | Information |
|---|---|
| 1 | <NewDataSet> |
| 2 | <TABLE> |
| 3 | <status>error</status> |
| 4 | <errorcode>errorcode</errorcode> |
| 5 | <errorid>errorid</errorid> |
| 6 | <message> errormsg</message> |
| 7 | </TABLE> |
| 8 | <NewDataSet> |

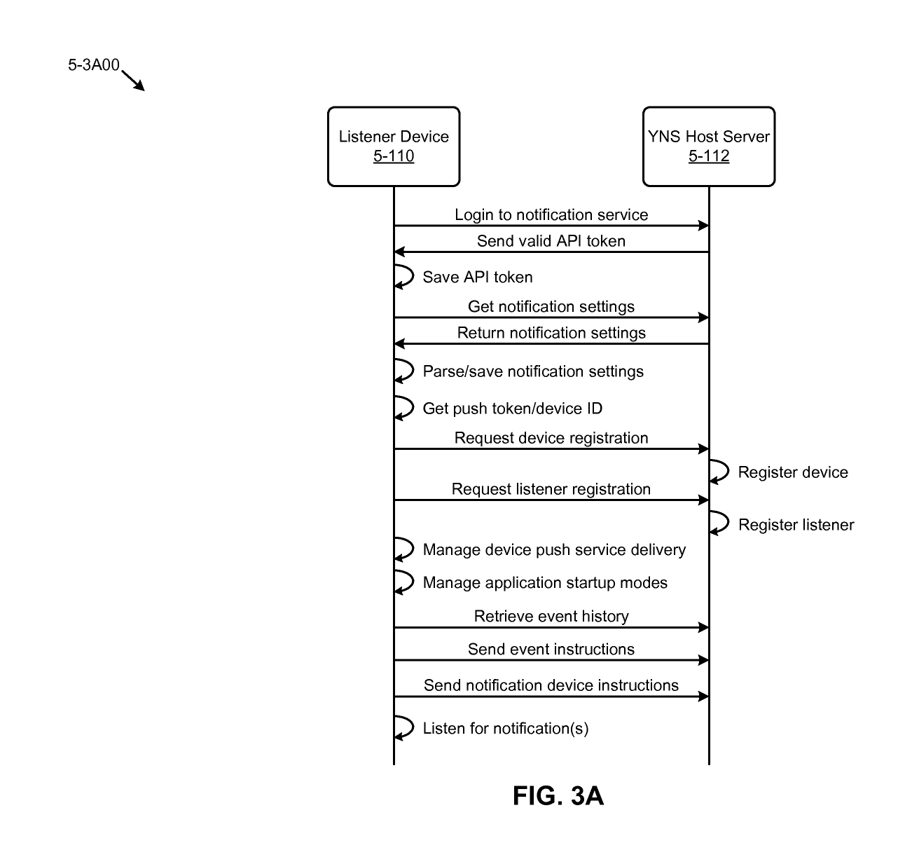

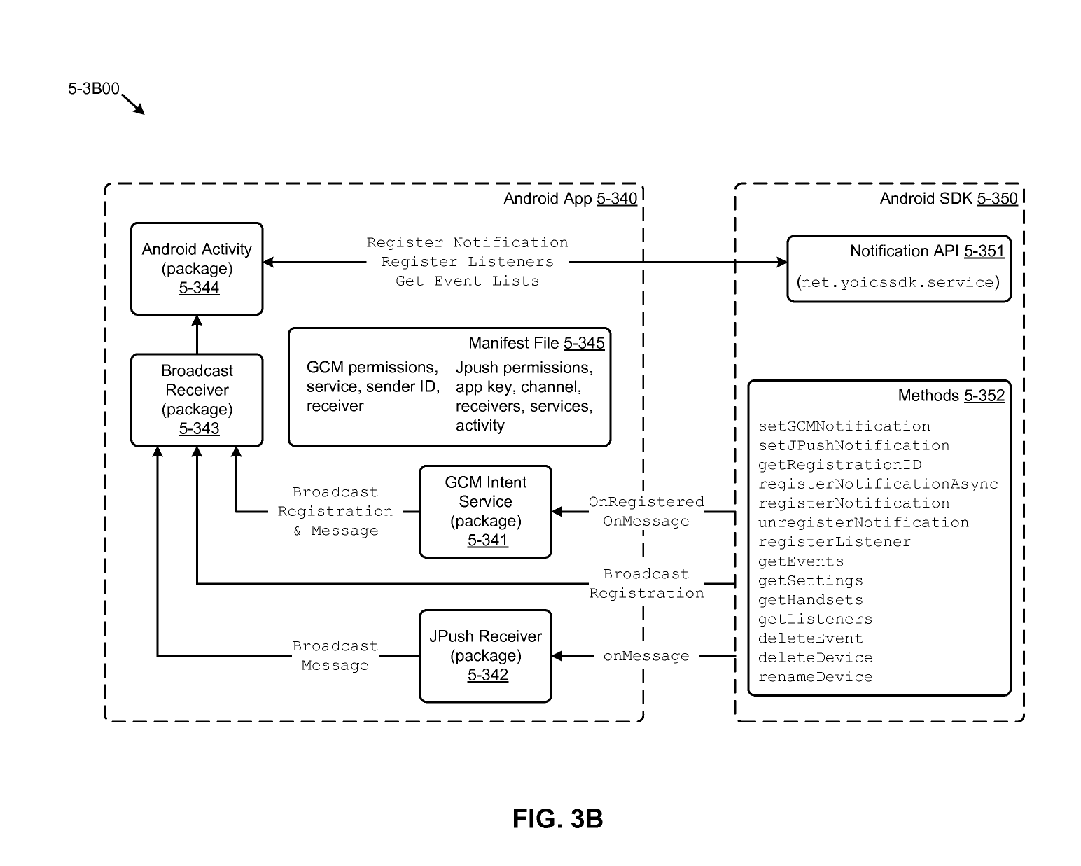

FIG. 3A is a diagram showing a listener device protocol 5-3A00 for use in systems that use multiple connection URLs to enable load balanced inter-device messaging, in one embodiment. As an option, one or more instances of listener device protocol 5-3A00 or any aspect thereof may be implemented in the context of the architecture and functionality of various embodiments described herein. Also, listener device protocol 5-3A00 or any aspect thereof may be implemented in any desired environment.

The listener device protocol 5-3A00 comprises the aspects shown. This exemplary embodiment as well as other embodiments may implement additional features. Listener device protocol 5-3A00 depicts operations and communications on and among listener device 5-110 and YNS host server 5-112 from environment 5-1A00. In general, listener device 5-110 running a client application must first be authorized by the YNS before it can call the YNS for notification settings and features. This requires the YNS to process a security authorization (e.g., logging in to the YNS using a login API at authentication module 5-134 from system 5-1B00, or a “platform-specific” SDK), sending a valid API token to listener device 5-110, and listener device 5-110 saving and using the valid API token when interacting with the NS. If an invalid token error response is received during authorization, for example, the client app must be authorized again to obtain a new token.

Tokens may expire at any time based on service usage and security settings. After these initialization steps, the client app on listener device 5-110 can manage notification settings and configuration by first asking the YNS for the current user's notification settings (e.g., global settings, mobile handsets, listener devices, notification devices, etc.), and then parsing and saving the returned notification settings information. Next, the client app will need to register the user's mobile handset. The registration process can vary with the mobile handset platform, but each of the processes are very well defined by the platform manufacturer (e.g., Apple, Google, etc.). In one example, as shown in listener device protocol 5-3A00, registration of listener device 5-110 calls for listener device 5-110 to get a push token and a unique device ID. A push token is a unique identifier provided by a push service that maps the user's handset to the client application. Both Apple iOS and Google Android SDKs, for example, provide the push token service to mobile applications. Also, the unique device ID can be obtained from the platform SDK. This ID should be saved as it will be needed to register listener device 5-110 as a “listener” (see below). With this information, listener device 5-110 can then request device registration from the NS, which can then register the device (e.g., at registration module 5-135 of system 5-1B00).

The second step in receiving notifications is to register listener device 5-110 as a “listener” with the NS. This registration provides a virtual mapping of one or more listener devices to one or more notification devices. This mapping include how to send notification messages received from a notification device to specific listener devices (e.g., mobile handsets). There may be multiple listener devices registered. Specifically, referring to listener device protocol 5-3A00, the client app at listener device 5-110 can request listener registration using the unique device ID of listener device 5-110 and notification device ID (e.g., from user notification settings) of the target notification device. With this information, the YNS at YNS host server 5-112 (e.g., using registration module 5-135) can register the listener. To remove a listener, the client app can make the same API call with the remove action. During device registration, the client app must inform the YNS that a new device is being registered. This allows the YNS to perform privacy checks and clean up any older settings and events from previous registrations for the specific device. This step must be performed under very specific conditions. The client app must call the YNS during pre-registration after removing the device and before registering the device. This step prevents potential security vulnerabilities between device registrations where a device may have been previously registered by another user.

Other operations between and among listener device 5-110 and YNS host server 5-112 are also shown in listener device protocol 5-3A00, including: (1) manage the mobile platform's push service delivery methods for in-app notifications; (2) manage the mobile platform's application startup modes to detect being started as a result of an out-app notification event and immediately display the relevant content; (3) retrieve event history (e.g., notification history, or a saved listing of recent messages from a notification device for one or more listener devices) from the YNS show the user's recent events; (4) send the YNS instructions on clearing events from the event history; and (5) send the YNS instructions on renaming and deleting notification devices as appropriate for the application. In some embodiments, some user accounts can have service restrictions, where the YNS allows notification delivery and saves notification history based on published service levels. These service levels and settings are specific to each YNS user and may change accordingly. These settings typically affect items such as push delivery methods, push message frequency, and save event history. Further, some user accounts can qualify for an event cloud provisioning and storage service. If enabled, the provisioning API in the YNS (e.g., at provisioning module 5-136) is activated to provision the storage using a storage service. After provisioning, the client app can configure devices to use the storage service. When listener device 5-110 has been completely setup with the NS, it can then listen for notifications.

The following describes in more detail implementations of listener device protocol 5-3A00 (e.g., as the client API), according to some embodiments.

API Login—

the YNS API uses the Yoics Service API for authenticating the client API requests. This involves logging in to the Yoics Service API to obtain an authentication and authentication token. All Yoics related handset applications would already have done the login to authenticate the user, for which the API token is then easily obtained in the login response message. This authentication token will be referred to as the ‘<yoicstoken>’.

Apple Push Registration—

iOS applications must contact the APNS to obtain a registration token. This process informs the APNS that this application has been authorized to receive push notifications. The process will return an APNS token that must be provided to the YNS during handset registration. This token will be referred to as ‘<apnstoken>’ or, more generically, as ‘<pushtoken>’ when iOS handsets are involved.

Google GCM Registration—

Android applications must contact the GCM service to obtain a registration token. This process informs the GCM that this application has been authorized to receive push notifications. The process will return a GCM token that must be provided to the YNS during handset registration. This token will be referred to as ‘<gcmtoken>’ or, more generically, as ‘<pushtoken>’ when Android handsets are involved. Note, Google C2DM registration is no longer supported by Google.

JPush Registration—

Android applications must contact the JPush service to obtain a registration token. This process informs the JPush that this application has been authorized to receive push notifications. The process will return a JPush token that must be provided to the YNS during handset registration. This token will be referred to as ‘<jpushtoken>’ or, more generically, as ‘<pushtoken>’ when Android handsets are involved.

YNS Handset Registration—

Each handset intending to receive notifications from the YNS must be registered with the YNS. This requires the handset to send its unique identifier and the appropriate <pushtoken> to the YNS. The YNS will save this information for use in delivery notifications that arrive from the user's YNS enabled products. As an example, before an iOS device is registered for receiving notifications, ServerCallYNSAPI class must be initialized with the appropriate yoicsID, YoicsToken and PushToken as shown in Table 11.

TABLE 11

| Ref | Information |
|---|---|
| 1 | (void) initializeWithYoicsID:(NSString*)yoicsID |
| 2 | yoicsToken:(NSString*)yoicsToken |
| 3 | apnsToken:(NSString*)apnsToken; |

YNS Handset Registration Request—

Once a push registration has been acquired from the appropriate push service, the handset registration request can be sent to the YNS.

YNS Handset Registration Request Format—

To register or enable an iOS device handset to receive notifications, use the below API defined in ServerCallYNSAPI.m, as shown in Table 12.

TABLE 2

| Ref | Information | |
|---|---|---|
| 1 | (void) registerHandsetWithPushEnabled:(BOOL)pushEnabled | |
| 2 | smtpEnabled:(BOOL)smtpEnabled | |
| 3 | success:(void (\hat{ })(NSDictionary*response))success | |
| 4 | failure:(void (\hat{ })(NSError *error))failure; | |
| 5 | Example: | |
| 6 | [[ServerCallYNSAPI sharedClient] registerHandsetWithPushEnabled:pushEnabled | |
| 7 | smtpEnabled:smtpEnabled | |
| 8 | success:\hat{ }(NSDictionary *response) { | |
| 9 | <some-success-handler-code> | |
| 10 | } | |
| 11 | failure:\hat{ }(NSError * error) | |
| 12 | { | |
| 13 | <some-failure-handler-code> | |
| 14 | } | |
| 15 | ]; | |
| 16 | The following is an example of the calling format. | |
| 17 | http://<server>/register_handset.php?yoicsid=<yoicsid>&yoics_token=<yoics_token>&push_ | |
| | token=<push_token>>&push_system=<push_system>&handset_uid=<handset_uid> | |
| | &platform=<platform>&manufacturer=<manufacturer>&version=<version>>&mode=<mode> | |
| | &type=<respformat> | |
| 18 | where | |
| 19 | <yoicsid> | is the registered user's Yoics account (Base64) |
| 20 | <email> | is the registered user's email address (Base64) |
| 21 | <yoics_token> | is the Yoics login token received from the Login API |
| 22 | <push_token> | is push registration token from APNS, GCM, JPush |
| 23 | <push_system> | is push system identifier APNS, GCM or JPush [1] |
| 24 | <handset_uid> | unique handset ID from the mobile device |
| 25 | <platform> | is the mobile handset type (ANDROID or IOS) |
| 26 | <manufacturer> | is the mobile handset manufacturer (Apple, Samsung, etc.) |
| 27 | <version> | is the mobile handset OS version |
| 28 | <mode> | is the mobile application notification mode |
| 29 | <push> | indicates if the user wants push notifications (yes or no) |
| 30 | <smtp> | indicates if the user wants SMTP notifications (yes or no) |

| | |
|---|---|
| 31 | Note [1]: optional field (defaults to APNS on iOS, GCM on Android) |

To unregister/disable a handset from receiving notifications use the below API defined in ServerCallYNSAPI.m, as shown in Table 13.

TABLE 3

| Ref | Information |
|---|---|
| 1 | + (void) unregisterHandsetWithSuccess:(void (\hat{ }) |
| | (NSDictionary*response))success |
| 2 | failure:(void (\hat{ })(NSError *error))failure; |

YNS Handset Registration Response—

The response will either be in json format or in xml format depending on the “type” parameter. The default is “xml” if no format is provided. If the response format is json and the operation succeeds the response will be as shown in Table 14.

TABLE 4

| Ref | Information |
|---|---|
| 1 | { “NewDataSet”: { “TABLE”: [ {“status”: “ok”}] }} |

If the response format is json and an error occurs the response will be as shown in Table 15.

TABLE 5

| Ref | Information |
|---|---|
| 1 | { “NewDataSet”: {“TABLE”: [ {“status”: “error”, |
| | “error”:”<errorcode>”, “errorid”:”<errorid>”, |
| | “message”:”<errormessage>”}] }} |

If the format is xml and operation succeeds the response will be as shown in Table 16.

TABLE 6

| Ref | Information |
|---|---|
| 1 | <NewDataSet> |
| 2 | <TABLE> |
| 3 | <status>ok</status> |
| 4 | </TABLE> |
| 5 | </NewDataSet> |

If the response format is xml and an error occurs the response will be as shown in Table 17.

TABLE 7

| Ref | Information |
|---|---|
| 1 | <NewDataSet> |
| 2 | <TABLE> |
| 3 | <status>error</status> |
| 4 | <errorcode>errorcode</errorcode> |
| 5 | <errorid>errorid</errorid> |
| 6 | <message> errormsg</message> |
| 7 | </TABLE> |
| 8 | </NewDataSet> |

YNS Handset Registration Possible Error Codes—

The following <errorcode>, <errorid>, <message> attributes may be received from the API as shown in Table 18.

TABLE 8

| Ref | Information |
|---|---|
| 1 | ″InvalidToken″, ″1000″, ″The Yoics token failed validation″ |
| 2 | ″RegisterHandsetFailed″, ″1002″, “<textual explanation>” |
| 3 | ″RegisterUserFailed″, ″1001″, “<textual explanation>” |
| 4 | ″UnexpectedError″, ″9999″, “<textual explanation>” |

YNS Device Listener Registration Request—

Once a handset has been registered with the YNS, the user may request to receive notification events (called a listener) coming from one of their YNS enabled devices.

YNS Device Listener Request Format—

Use below API defined in ServerCallYNSAPI.m to add an iOS device as a listener as shown in Table 19.

TABLE 9

| Ref | Information | |
|---|---|---|
| 1 | + (void) registerDeviceListenerWithDeviceUID:(NSString*)deviceUID | |
| 2 | success:(void (\hat{ })(NSDictionary *response))success | |
| 3 | failure:(void (\hat{ })(NSError *error))failure; | |
| 4 | Example: | |
| 5 | http://<server>/register_listener.php?yoicsid=<yoicsid> | |
| | &yoics_token=<yoics_token>&devicve_uid=<device_uid> | |
| | &handset_uid=<handset_uid>&action=<action>&type=<respformat> | |
| 6 | where, | |
| 7 | <yoicsid> | is the registered users Yoics account (Base64) |
| 8 | <yoics_token> | is the Yoics login token received from the Login API |
| 9 | <handset_uid> | unique handset ID from the mobile device |
| 10 | <device_uid> | is the Yoics device's unique identifier |
| 11 | <action> | indicates either ‘add’ or |
| | | ‘remove’ listener (add or remove) |

Use below API defined in ServerCallYNSAPI.m to remove a handset as a listener for a particular Yoics enabled device as shown in Table 20.

TABLE 20

| Ref | Information |
|---|---|
| 1 | + (void) unregisterDeviceListenerWithDeviceUID:(NSString*) |
| | deviceUID |
| 2 | success:(void (\hat{ })(NSDictionary *response))success |
| 3 | failure:(void (\hat{ })(NSError *error))failure; |

YNS Device Listener Response—

The response will either be in json format or in xml format depending on the “type” parameter. The default is “xml” if no format is provided. If the response format is json and the operation succeeds the response will be as shown in Table 21.

TABLE 21

| Ref | Information |
|---|---|
| 1 | { “NewDataSet”: { “TABLE”: [ {“status”: “ok”}] }} |

If the response format is json and an error occurs the response will be as shown in Table 22.

TABLE 10

| Ref | Information |
|---|---|
| 1 | { “NewDataSet”: { “Table”: [ {“status”: “error”, “error”:“<errorcode>”, “errorid”:“<errorid>”, |
| | “message”:“<errormessage>”}] }} |

If the format is xml and operation succeeds the response will be as shown in Table 23.

TABLE 11

| Ref | Information |
|---|---|
| 1 | <NewDataSet> |
| 2 | <Table> |
| 3 | <status>ok</status> |
| 4 | </Table> |
| 5 | </NewDataSet> |

If the response format is xml and an error occurs the response will be as shown in Table 24.

TABLE 12

| Ref | Information |
|---|---|
| 1 | <NewDataSet> |
| 2 | <Table> |
| 3 | <status>error</status> |
| 4 | <errorcode>errorcode</errorcode> |
| 5 | <errorid>errorid</errorid> |
| 6 | <message> errormsg</message> |
| 7 | </Table> |
| 8 | </NewDataSet> |

YNS Device Listener Registration Possible Error Codes—

The following <errorcode>, <errorid>, <message> attributes may be received from the API as shown in Table 25.

TABLE 13

| Ref | Information |
|---|---|
| 1 | “InvalidToken”, “1000”, “The Yoics token failed validation” |
| 2 | “ListenerFailed”, “2003”, “Listener failed to get added to database” |
| 3 | “UnknownDevice”, “2002”, “no device found:” <device_uid> |
| 4 | “UnknownHandset”, “2001”, “no handset found:” <handset_uid> |
| 5 | “UnexpectedError”, “9999”, “<textual explanation>” |

YNS Event History Request—

At any time, the mobile application may request a list of the events for their account. This history includes all notification events received from their YNS enabled products and saved according the service definition for their account.

YNS Event History Format—

The following APIs for an iOS app are defined in ServerCallYNSAPI.m to get the event history as shown in Table 26.

TABLE 14

| Ref | Information |
|---|---|
| 1 | + (void) getEventHistoryWithSuccess:(void (\hat{ })(NSDictionary |
| | *response))success |
| | failure:(void (\hat{ })(NSError *error))failure; |
| 2 | Example: |
| 3 | [[ServerCallYNSAPI sharedClient ] getEventHistoryWithSuccess: |
| 4 | \hat{ }(NSDictionary *response) { |
| 5 | <some-success-handler-code> |
| 6 | } |
| 7 | failure:\hat{ }(NSError * error) { |
| 8 | <some-failure-handler-code> |
| 9 | } |
| 10 | ]; |

To get the event history based on the index (of events that happened) use the following API defined in ServerCallYNSAPI.m, as shown in Table 27.

TABLE 15

| Ref | Information |
|---|---|
| 1 | + (void) getEventHistoryFromIndex:(int)fromIndex |
| 2 | numberEvents:(int)numberEvents |
| 3 | WithSuccess:(void (\hat{ })(id responseObject))success |
| 4 | failure:(void (\hat{ })(NSError *error))failure; |

To get the total numbers of events that occurred use the following API defined in ServerCallYNSAPI.m, as shown in Table 28.

TABLE 16

| Ref | Information |
|---|---|
| 1 | + (void)getEventsCountSuccess:(void (\hat{ })(id responseObject))success |
| | failure:(void (\hat{ })(NSError *error))failure; |

The following Table 29 is an example of the calling format, in one embodiment:

TABLE 17

| Ref | Information | |
|---|---|---|
| 1 | http://<server>/event_history.php?yoicsid=<yoicsid>&yoics_token=<yoics_token>&action | |
| | =list&type=<respformat> | |
| 2 | where | |
| 3 | <yoicsid> | is the registered users Yoics account (Base64) |
| 4 | <yoics_token> | is the Yoics login token received from the Login API |

YNS Event History Response—

The response will either be in json format or in xml format depending on the “type” parameter. The default is “xml” if no format is provided. If the format is xml and the operation succeeds the response will be as shown in Table 30.

TABLE 30

| Ref | Information | |
|---|---|---|
| 1 | <NewDataSet> | |
| 2 | <Table> | |
| 3 | <id>1</id> | |
| 4 | <device_uid>00:00:00:00:00:00:00:01</device_uid> | |
| 5 | <message>aHR0cDovL3d3dy55b3V0dWJILmNvbS93YXRjaD92PXFBYkdtTVBGYnk0</ | |
| | message> | |
| 6 | <timestamp>20120118095222</timestamp> | |
| 7 | <status>new</status> | |
| 8 | <type>video</type> | |
| 9 | <updated>1327477743</updated> | |
| 10 | <created>1327477743</created> | |
| 11 | <delivered>1327477743</delivered> | |
| 12 | </Table> | |
| 13 | <Table> | |
| 14 | <id>2</id> | |
| 15 | <device_uid>00:00:00:00:00:00:00:01</device_uid> | |
| 16 | <message>aHR0cDovL3d3dy55b3V0dWJILmNybS93YXRjaD92PXFBYkdtTVBGYnk0</ | |
| | message> | |
| 17 | <timestamp>20120118095228</timestamp> | |
| 18 | <status>new</status> | |
| 19 | <type>video</type> | |
| 20 | <updated>1327477772</updated> | |
| 21 | <created>1327477772</created> | |
| 22 | <delivered>1327477772</delivered> | |
| 23 | </Table> | |
| 24 | </NewDataSet> | |
| 25 | where | |
| 26 | <id> | is the the unique ID for the event |
| 27 | <device_uid> | is the originating Yoics device's unique ID |
| 28 | <message> | is the notification message generated by the device (Base64) |
| 29 | <timestamp> | is the timestamp as received from the device |
| 30 | <status > | is current status of the event (new, pending, delivered) |
| 31 | <type > | is the event type as received from the device (video, audio) |
| 32 | <updated > | is the YNS timestamp of the last updated status |
| 33 | <created > | is the YNS timestamp when the event was recorded |
| 34 | <delivered> | is the YNS timestamp when the event was delivered to the |

messaging system (APNS, GCM, JPush, SMTP)

If the response format is json and an error occurs the response will be as shown in Table 31.

TABLE 31

| Ref | Information |
|---|---|
| 1 | { |
| 2 | newdataset:{ |
| 3 | table:[ |
| 4 | { |
| 5 | id:1, |
| 6 | device_uid:‘00:00:00:00:00:00:00:01’, |
| 7 | message:‘aHR0cDovL3d3dy55b3V0dWJILmNvbS93YXRjaD92PXFBYkdtTVBGYnk0’, |
| 8 | timestamp:20120118095222, |
| 9 | status:‘new’, |
| 10 | type:‘video’, |
| 11 | updated:‘1327477743’, |
| 12 | created:‘1327477743’, |
| 13 | delivered:‘1327477743’ |
| 14 | }, |
| 15 | { |
| 16 | id:2, |
| 17 | device_uid:‘00:00:00:00:00:00:00:01’, |
| 18 | message:‘aHR0cDovL3d3dy55b3V0dWJILmNvbS93YXRjaD92PXFBYkdtTVBGYnk0’, |
| 19 | timestamp:20120118095228, |
| 20 | status:‘new’, |
| 21 | type:‘video’, |
| 22 | updated:‘1327477772’, |
| 23 | created:‘1327477772’, |
| 24 | delivered:‘1327477772’ |
| 25 | } |
| 26 | ] |
| 27 | } |
| 28 | } |

If the response format is xml and an error occurs the response will be as shown in Table 32.

TABLE 18

| Ref | Information |
|---|---|
| 1 | <NewDataSet> |
| 2 | <Table> |
| 3 | <status>error</status> |
| 4 | <errorcode>errorcode</errorcode> |
| 5 | <errorid>errorid</errorid> |
| 6 | <message>errormsg</message> |
| 7 | </Table> |
| 8 | </NewDataSet> |

### YNS Event History Possible Error Codes

Some YNS event history error codes are given in Table 33.

TABLE 19

| Ref | Information |
|---|---|
| 1 | “InvalidToken”, “1000”, “The Yoics token failed validation” |
| 2 | “UnexpectedError”, “9999”, “<textual explanation>” |

YNS Event Deletion—

At any time, the mobile application may request to delete an event from their event history. This deletion will permanently remove the record from YNS. Table 34 is an example of the calling format, in one embodiment.

TABLE 20

| Ref | Information |
|---|---|
| 1 | http://<server>/event_history.php?yoicsid=<yoicsith&yoics_token=<yoics_token> |
| | &device_uid=<device_uid>&timestamp=<timestamp>&action=<delete_action>&type= |
| | <respformat> |
| 2 | where |
| 3 | <yoicsid> is the registered users Yoics account (Base64) |
| 4 | <yoics_token> is the Yoics login token received from the Login API |
| 5 | <device_uid> is the Yoics device UID for the saved event |
| 6 | <device_action> is the delete action or delete scope (see below) |
| 7 | <timestamp> is the event timestamp as received from the device |
| 8 | <delete_action> or delete scope: |
| 9 | “delete” - uses the <timestamp> to find exact matches for deleting events for the |
| | specified <yoicsid> and <device_uid>. |
| 10 | “deleteall” - ignores the <timestamp> for deleting events for the specified |
| | <yoicsid> and <device_uid>. |
| 11 | “deleteday” - uses the year, month, day of the <timestamp> for deleting events for |
| | the specified <yoicsid> and <device_uid>. |
| 12 | “deleteallbyuser” - ignores the <timestamp> for deleting events for the |
| | specified <yoicsid>, ignoring the device_uid and including all applicable devices. |
| 13 | “deletedaybyuser” - uses the year, month, day of the <timestamp> for deleting |
| | events for the specified <yoicsid>, ignoring the device_uid and including all |
| | applicable devices. |

Table 35 shown the APIs defined in ServerCallYNSAPI.m for deleting event history, in one embodiment.

TABLE 21

| Ref | Information |
|---|---|
| 1 | Delete event of a device of given time (action=delete) : |
| 2 | + (void) deleteEventWithDeviceAddress:(NSString*)deviceAddress |
| 3 | timestamp:(NSString*)timestamp |
| 4 | success:(void (\hat{ })(NSDictionary *response))success |
| 5 | failure:(void (\hat{ })(NSError *error))failure; |
| 6 | Delete all events of a Device(action=deleteall) : |
| 7 | + (void) deleteAllEventsWithDeviceAddress:(NSString*)deviceAddress |
| | success:(void ( )(NSDictionary *response))success |
| 8 | failure:(void (\hat{ })(NSError *error))failure; |
| 9 | Delete all events of a device of a specific EventType |
| | (action=deleteallbytype) : |
| 10 | + (void) deleteAllEventsWithDeviceAddress:(NSString*)deviceAddress |
| 11 | eventType:(NSString*)eventType |
| 12 | success:(void (\hat{ })(NSDictionary *response))success |
| 13 | failure:(void (\hat{ })(NSError *error))failure; |
| 14 | Delete all events of a user of all devices (action=deleteallbyuser) : |
| 15 | + (void) deleteAllEventsWithSuccess:(void (\hat{ })(NSDictionary |
| | *response))success |
| | failure:(void (\hat{ })(NSError *error))failure; |
| 16 | Delete all events of a user of a device with specific UID (action= |
| | deleteallbyuser) : |
| 17 | + (void) deleteAllEventsByUserWithDeviceAddress: |
| | (NSString*)deviceAddress |
| 18 | success:(void (\hat{ })(NSDictionary *response))success |
| 19 | failure:(void (\hat{ })(NSError *error))failure; |
| 20 | Delete all events of all devices of a user by date |
| | (action=deletedaybyuser) : |
| 21 | + (void) deleteAllEventsByDate:(NSString *)dateDelete |
| 22 | success:(void (\hat{ })(id responseObject))success |
| 23 | failure:(void (\hat{ })(NSError *error))failure; |
| 24 | Delete all events of a specified device of a user by date |
| | (action=deleteday) |
| 25 | + (void) deleteAllEventsByDate:(NSString *)dateDelete |
| 26 | deviceAddress:(NSString*)deviceAddress |
| 27 | success:(void (\hat{ })(NSDictionary *response))success |
| 28 | failure:(void (\hat{ })(NSError *error))failure; |

YNS Event Deletion Response—

The response will either be in json format or in xml format depending on the “type” parameter. The default is “xml” if no format is provided. If the response format is json and the operation succeeds the response will be as shown in Table 36.

TABLE 22

| Ref | Information |
|---|---|
| 1 | { “NewDataSet”: { “Table”: [ {“status”: “ok”}] }} |

If the response format is json and an error occurs the response will be as shown in Table 37.

TABLE 23

| Ref | Information |
|---|---|
| 1 | { “NewDataSet”: { “Table”: [ {“status”: “error”, “error”:“<errorcode>”, “errorid”:“<errorid>”, |
| | “message”:“<errormessage>”}] }} |

If the format is xml and operation succeeds the response will be as shown in Table 38.

TABLE 24

| Ref | Information |
|---|---|
| 1 | <NewDataSet> |
| 2 | <Table> |
| 3 | <status>ok</status> |
| 4 | </Table> |
| 5 | </NewDataSet> |

If the response format is xml and an error occurs the response will be as shown in Table 39.

TABLE 25

| Ref | Information |
|---|---|
| 1 | <NewDataSet> |
| 2 | <Table> |
| 3 | <status>error</status> |
| 4 | <errorcode>errorcode</errorcode> |
| 5 | <errorid>errorid</errorid> |
| 6 | <message> errormsg</message> |
| 7 | </Table> |
| 8 | </NewDataSet> |

### YNS Event Deletion Possible Error Codes

Table 40 is an example of the calling format, in one embodiment.

TABLE 40

| Ref | Information |
|---|---|
| 1 | “InvalidToken”, “1000”, “The Yoics token failed validation” |
| 2 | “UnexpectedError”, “9999”, “<textual explanation>” |

YNS Get User Settings—

At any time, the mobile application may request the notification settings for the user. This is likely needed to confirm settings and display correct settings to the user.

YNS Get User Settings Format—

The following is an example of the calling format as shown in Table 41.

TABLE 41

| Ref | Information | |
|---|---|---|
| 1 | http://<server>/ | |
| | user_settings.php?action=settings&yoicsid=<yoicsid>&type= | |
| | <respformat> | |
| 2 | where | |
| 3 | <yoicsid> | is the registered users Yoics account (Base64) |
| 4 | <respformat> | response format as json or xml |
| 5 | <action> | is the settings (see below) |
| 6 | <device_uid> | optional parameter for renamedevice and |
| | deletedevice actions | |
| 7 | <device_name> | optional parameter for ranemdevice action |

| | |
|---|---|
| 8 | Settings Action: |
| 9 | “settings” - returns the YNS Global Settings for the specified |
| | <yoicsid>. |
| 10 | “handsets” - returns the Mobile Handsets for the specified <yoicsid>. |
| 11 | “listeners” - returns the Device Listeners for the specified <yoicsid> |
| 12 | “renamedevice” - informs YNS that a device rename is requested |
| | <yoicsid>. This action requires the <device_uid> and |
| | <device_name> parameters. |
| 13 | “deletedevice” - informs YNS that a device delete is requested |
| | <yoicsid>. This action requires the <device_uid> parameter. |
| 14 | “verifystorage” - informs to provision storage for the requested |
| | <yoicsid>. This action requires the <email> parameter indicating |
| | the user's registered email address and the <yoics_token> |
| | parameter representing an active Yoics API token. |

The following are the API's defined in ServerCallYNSAPI.m for user settings as shown in Table 42.

TABLE 26

| Ref | Information |
|---|---|
| 1 | action=settings : |
| 2 | + (void) getUserSettingsWithSuccess:(void (\hat{ })(NSDictionary |
| | *response))success |
| | failure:(void (\hat{ })(NSError *error))failure; |
| 3 | action=provisionkii : |
| 4 | + (void) getYoicsStorageAccount:(void (\hat{ })(id response))success |
| 5 | failure:(void (\hat{ })(NSError *error))failure; |
| 6 | action=verifystorage : |
| 7 | + (void) verifyYoicsStorageSettingsWithSuccess:(void (\hat{ })(id |
| | response))success |
| | failure:(void (\hat{ })(NSError *error))failure; |
| 8 | action=listeners : |
| 9 | + (void) getDeviceListenersWithSuccess:(void (\hat{ })(NSDictionary |
| | *response))success |
| | failure:(void (\hat{ })(NSError *error))failure; |
| 10 | action=deletedevice |
| 11 | + (void)deleteNotificationDeviceUid:(NSString*)deviceUid |
| 12 | success:(void (\hat{ })(id responseObject))success |
| 13 | failure:(void (\hat{ })(NSError *error))failure; |
| 14 | action=renamedevice |
| 15 | + (void)renameNotification:(NSString*)deviceName |
| 16 | deviceUid:(NSString*)deviceUid |
| 17 | success:(void (\hat{ })(id responseObject))success |
| 18 | failure:(void (\hat{ })(NSError *error))failure; |
| 19 | action=settings : |
| 20 | + (void)getNotificationSettingsSuccess:(void (\hat{ })(id |
| | responseObject))success |
| | failure:(void (\hat{ })(NSError *error))failure; |
| 21 | action=listeners |
| 22 | + (void)getNotificationListenerSuccess:(void (\hat{ })(id |
| | responseObject))success |
| | failure:(void (\hat{ })(NSError *error))failure; |

YNS Get User Settings Response—

The response will either be in json format or in xml format depending on the “type” parameter. The default is “xml” if no format is provided. If the response format is json and the operation succeeds the response will be as shown in Table 43.

TABLE 27

| Ref | Information |
|---|---|
| 1 | {“Table”:{“yoicsid”:“user”,“email”:“email@domain.com”,“level”:“BASIC or |
| | PRO”,“push”:“yes or no”,“smtp”:“yes or no”,“created”:“Epoch date”,“updated”:“Eposh |
| | date”}} |

If the response format is json and an error occurs the response will be as shown in Table 44.

TABLE 28

| Ref | Information |
|---|---|
| 1 | { “NewDataSet”: { “Table”: [ {“status”: “error”, “error”:“<errorcode>”, “errorid”:“<errorid>”, |
| | “message”:“<errormessage>”}] }} |

If the format is xml and operation succeeds the response will be as shown in Table 45.

TABLE 29

| Ref | Information |
|---|---|
| 1 | User Setting Response |
| 2 | <NewDataSet> |
| 3 | <Table> |
| 4 | <yoicsid>dolkein</yoicsid> |
| 5 | <email>dolkein</email> |
| 6 | <level>BASIC</level> |
| 7 | <push>yes</push> |
| 8 | <smtp>no</smtp> |
| 9 | <created>1330465582</created> |
| 10 | <updated>1330465582</updated> |
| 11 | </Table> |
| 12 | </NewDataSet> |
| 13 | Mobile Handset Response |
| 14 | <NewDataSet> |
| 15 | <Table> |
| 16 | <handset_uid>fac245967e34734ddb76d5184aa938f317fee097 </handset_uid> |
| 17 | <push_token>574753c9 b4010703 269a4ebb 1c47b6a9 19f89c1e cbf8dc59 2a21828d |
| | 2ad090ef </push_token> |
| 18 | <platform>iOS</platform> |
| 19 | <manufacturer>Apple</manufacturer> |
| 20 | <mode>P:com.philips.cl.insight.bet </mode> |
| 21 | <version>5.0</version> |
| 22 | <created>1330465582</created> |
| 23 | <updated>1330465582</updated> |
| 24 | </Table> |
| 25 | <Table> |
| 26 | <handset_uid>9b23dcdfbaba0c854242946dd70344c8213f3785</handset_uid> |
| 27 | <push_token>e2e12ed 073b1e19 9dbda9b0 31ce5d31 80fe593a 52d4f107 52a8a453 |
| | cf153520</push_token> |
| 28 | <platform>iOS</platform> |
| 29 | <manufacturer>Apple</manufacturer> |
| 30 | <mode>P:com.philips.cl.insight.bet </mode> |
| 31 | <version>4.3.5</version> |
| 32 | <created>1330465582</created> |
| 33 | <updated>1330465582</updated> |
| 34 | </Table> |
| 35 | </NewDataSet> |
| 36 | Device Listeners Response |
| 37 | <NewDataSet> |
| 38 | <Table> |
| 39 | <handset_uid>fac245967e34734ddb76d5184aa938f317fee097</handset_uid> |
| 40 | <device_uid>00:00:48:02:2A:A0:07:88</device_uid> |
| 41 | <created>1330465582</created> |
| 42 | <updated>1330465582</updated> |
| 43 | </Table> |
| 44 | <Table> |
| 45 | <handset_uid>fac245967e34734ddb76d5184aa938f317fee097 </handset_uid> |
| 46 | <device_uid>00:00:00:E0:4C:A9:55:65</device_uid> |
| 47 | <created>1330465582</created> |
| 48 | <updated>1330465582</updated> |
| 49 | </Table> |
| 50 | </NewDataSet> |

If the response format is xml and an error occurs the response will be as shown in Table 46.

TABLE 30

| Ref | Information |
|---|---|
| 1 | <NewDataSet> |
| 2 | <Table> |
| 3 | <status>error</status> |
| 4 | <errorcode>errorcode</errorcode> |
| 5 | <errorid>errorid</errorid> |
| 6 | <message>errormsg</message> |
| 7 | </Table> |
| 8 | </NewDataSet> |

### YNS Get User Settings Possible Error Codes

Table 47 presents possible error codes, in one embodiment.

TABLE 31

| Ref | Information |
|---|---|
| 1 | “InvalidToken”, “1000”, “The Yoics token failed validation“ |
| 2 | “InvalidUser”, “6000”, “No user settings available” |
| 3 | “InvalidDevice”, “6001”, “Device not owned by user” |
| 4 | “InvalidDevice”, “6001”, “No device found” |
| 5 | “UnexpectedError”, “9999”, “<textual explanation>” |

FIG. 3B presents examples of usage scenarios 5-3B00 of an application programming interface for listener devices in systems that use multiple connection URLs to enable load balanced inter-device messaging, in one embodiment. As an option, one or more instances of usage scenarios 5-3B00 or any aspect thereof may be implemented in the context of the architecture and functionality of various embodiments described herein. Also, usage scenarios 5-3B00 or any aspect thereof may be implemented in any desired environment.

The usage scenarios 5-3B00 along with the following accompanying disclosure presents detailed information describing an example implementation of client applications and SDKs. (e.g., for a Google Android handset). Usage scenarios 5-3B00 illustrates one exemplary embodiment comprising an Android App 5-340 and an Android SDK 5-350, but other embodiments (e.g., for Apple iOS) are possible. As shown the Android App 5-340 comprises an Android activity package 5-344, a broadcast receiver 5-343, a manifest file 5-345, an intent service package 5-341, a JPush receiver package 5-342. Also, as shown the Android SDK 5-350 comprises a notification API 5-351, and a set of methods 5-352. The Android App 5-340 and Android SDK 5-350, together with constituent components and exemplary uses thereto are discussed herein.

Android Notification SDK—

The YNS Android SDK has storage and notification extensions to simplify the Java development for adding storage and notification services. The main class for adding notification services is the NotificationAPIManager.

### Instantiation

Table 48 depicts one possible instantiation syntax.

TABLE 32

| Ref | Information |
|---|---|
| | /* |
| | * <p> |
| | * Instantiate a new API Manager to use for accessing the API. |
| | * </p> |
| | * @param yoicsid |
| | * Yoics Id of the current user |
| | * @param email |
| | * Email of the current user |
| | * @param serverURL |
| | * Yoics API Server URL, like api.yoics.net/web/api/ |
| | * @param APIKey |
| | * Yoics API key provided by Yoics Inc when registering as a |
| | * developer. |
| | * @param useSSL |
| | * Indicate if Yoics API should be contacted using SSL |
| | * (recommended) |
| | * @param token |
| | * Yoics API token provided in the Login API |
| | */ |
| 15 | public NotificationAPIManager(String yoicsid, String email, String serverURL, String |
| | APIKey, boolean useSSL, String token) |

Push Registration—

Push registration changes with this version of the Yoics Android SDK. The interaction with Google GCM and JPush is abstracted into the Notification API to make it easier on the developer. The following flow shows how the developer should structure the application integration with the SDK.

GCM Registration—

Android apps must have access to a registered GCM account at Google. This account is tied specifically to the application package. Without it, notification will not work. Once the account is created and approved, there are several steps the application must perform. These steps are fully documented by Google. The critical pieces of data are the app package name and the GCM app ID and secret. These values must be registered with the Yoics service.

JPush Registration—

Android apps must have access to a registered JPush account at http://jpush.cn. JPush is intended for apps deployed into China. This account is tied specifically to the application package. Without it, notification will not work. Once the account is created and approved, there are several steps the application must perform. These steps are fully documented by Google. The critical pieces of data are the app package name and the JPush App ID and master secret. These values must be registered with the Yoics service.

### Methods

Table 49 depicts some possible methods to implement aspects of JPushNotification.

TABLE 33

| Ref | Information |
|---|---|
| 1 | public void setGCMNotification(String senderID, String pushDomain, |
| 2 | BroadcastReceiver receiver) |
| 3 | public void setJPushNotification(String push Domain) |
| 4 | public String getRegistrationID( ) |
| 5 | public boolean registerNotification(boolean push,boolean smtp, String push_token, String |
| | mode, Context context) |
| 6 | NOTE: Refer to HandsetRegistration API for mode specification |
| 7 | public boolean registerListener(String device_address, |
| 8 | boolean add, Context context) |
| 9 | public List<EventData> getEvents( ) |
| 10 | public List<NotificationSettingsData> getSettings( ) |
| 11 | public List<NotificationHandsetData> getHandsets( ) |
| 12 | public List<NotificationListenerData> getListeners( ) |
| 13 | public boolean deleteEvent(String device_address, |
| 14 | String timestamp, String action) |
| 15 | NOTE: Refer to Device Event API for action specification |
| 16 | public boolean deleteDevice(String device_address) |
| 17 | public boolean renameDevice(String yoicsid, String device_address, |
| 18 | String device_name) |
| 19 | public boolean provisionStorage( ) |

### Java SDK Examples

Table 50 depicts a possible Java SDK implementation.

TABLE 50

| Ref | Information |
|---|---|
| | Service Settings |
| | package net.yoicsexample; |
| | public class YoicsServiceSettings { |
| | public static String YOICS_API_KEY = “PhilipsAndroid”; |
| | public static String YOICS_API_SERVER = “server5.yoics.net/web/api/”; |
| | public static String YOICS_NOTIFICATION_API_SERVER = |
| | “notification.yoics.net/”; |
| | public static boolean YOICS_API_USE_SSL = false; |
| | } |
| | NoteL Modes identify the push domain. eg - net.yoics.launcher. They are derived from |
| | the package name used to register with the push delivery system (ie GCM or JPush) |
| | Calling Examples |
| | import net.yoicsexample.YoicsServiceSettings; |
| | import net.yoicssdk.data.*; |
| | import net.yoicssdk.service.*; |
| | ... |
| | LoginData login = api.login(username, password); |
| | if (login != null) } |
| | NotificationAPIManager apiNotify = new NotificationAPIManager( |
| | username, login.getEmail( ), |
| | YoicsServiceSettings.YOICS_NOTIFICATION_API_SERVER, |
| | YoicsServiceSettings.YOICS_API_KEY, |
| | YoicsServiceSettings.YOICS_API_USE_SSL, api.getToken( )); |
| | apiNotify.setGCMNotification( |
| | YoicsServiceSettings.YOICS_NOTIFICATION_GCM_SENDER, |
| | YoicsServiceSettings.YOICS_NOTIFICATION_DOMAIN, |
| | this.mHandleMessageReceiver); |
| | apiNotify.registerWithPushSystem( ); |
| | /* At this point, the receiver must handle registration completion |
| | and then call the code below */ |
| | } |
| | ... |
| | /* code from registration handler (receiver) */ |
| | String regid = apiNotify.getRegistrationID( ); |
| | // register handset |
| | apiNotify.registerNotification(true, true, regid, “<mode>”, context)); |
| | // register listener |
| | apiNotify.registerListener( |
| | username, dd.getDeviceAddress( ), true, getApplicationContext( )); |
| | // get user settings |
| | List<NotificationSettingsData> settings = |
| | apiNotify.getSettings( ); |
| | // get handsets |
| | List<NotificationHandsetData> handsets = |
| | apiNotify.getHandsets( ); |
| | // get listeners |
| | List<NotificationListenerData> listeners = |
| | apiNotify.getListeners( ); |
| | // rename device |
| | boolean renStatus = apiNotify.renameDevice(“00:00:48:02:2A:A0:07:XX”, “New Name”); |
| | List<EventData> events = apiNotify.getEvents( ); |
| | // delete device |
| | boolean delStatus = apiNotify.deleteDevice(“00:00:48:02:2A:A0:07:XX”); |

### Android GCM Manifest Settings

Table 51 depicts some possible settings to implement aspects of an Android GCM manifest.

TABLE 51

| Ref | Information |
|---|---|
| | /* Required permissions for */ |
| | <uses-permission android:name=“android.permission.INTERNET” /> |
| | <uses-permission |
| | android:name=“android.permission.WRITE_EXTERNAL_STORAGE” /> |
| | <uses-permission android:name=“android.permission.GET_TASKS” /> |
| | <uses-permission android:name=“android.permission.READ_PHONE_STATE” |
| | /> |
| | <uses-permission android:name=“android.permission.GET_ACCOUNTS” /> |
| | <uses-permission android:name=“android.permission.WAKE_LOCK” /> |
| | <uses-permission |
| | android:name=“com.google.android.providers.gsf.permission.READ_GSERVICES” /> |
| | <uses-permission |
| | android:name=“net.yoics.launcher.permission.C2D_MESSAGE”/> |
| | <uses-permission |
| | android:name=“com.google.android.c2dm.permission.RECEIVE”/> |
| | <permission android:name=“net.yoics.launcher.permission.C2D_MESSAGE” |
| | android:protectionLevel=“signature”/> |
| | /* Required for GCM Notification */ |
| | <service android:name=“GCMIntentService” |
| | android:exported=“false” |
| | android:enabled=“true”> |
| | </service> |
| | <meta-data android:name=“GCM_SENDER_ID” |
| | android:value=“716134499940” /> // Replace with production sender ID |
| | <receiver |
| | android:name=“com.google.android.gcm.GCMBroadcastReceiver” |
| | android:permission=“com.google.android.c2dm.permission.SEND” > |
| | <intent-filter> |
| | <action android:name=“com.google.android.c2dm.intent.RECEIVE” /> |
| | <action |
| | android:name=“com.google.android.c2dm.intent.REGISTRATION” /> |
| | <category android:name=“net.yoics.launcher” /> |
| | </intent-filter> |
| | </receiver> |

### Initiate Yoics Notification for Android GCM

Table 52 depicts an exemplary Yoics Notification for Android GCM initiation, in one embodiment.

TABLE 34

| Ref | Information |
|---|---|
| 1 | mAPI = new NotificationAPIManager(mUsername, mUserEmail, |
| 2 | YoicsServiceSettings.YOICS_NOTIFICATION_API_SERVER, |
| 3 | YoicsServiceSettings.YOICS_API_KEY, |
| 4 | YoicsServiceSettings.YOICS_API_USE_SSL, mToken, |
| 5 | this.getApplicationContext( )); |
| 6 | mAPI.setGCMNotification( |
| 7 | YoicsServiceSettings.YOICS_NOTIFICATION_GCM_ |
| | SENDER, |
| 8 | YoicsServiceSettings.YOICS_NOTIFICATION_DOMAIN, |
| 9 | this.mHandleMessageReceiver); |
| 10 | mAPI.registerWithPushSystem( ); |

GCM Intent Service—

The GCM Intent service responds to GCM broadcast messages related to registration and messages. This service must be packaged in the main activity namespace. Below is a code example as shown in Table 53.

TABLE 35

| Ref | Information |
|---|---|
| | package net.yoics.launcher; |
| | import net.yoics.service.YoicsServiceSettings; |
| | import net.yoicssdk.service.NotificationAPIManager; |
| | import android.app.IntentService; |
| | import android.content.Context; |
| | import android.content.Intent; |
| | import android.util.Log; |
| | import com.google.android.gcm.GCMBaseIntentService; |
| | import com.google.android.gcm.GCMRegistrar; |
| | /** |
| | * {@link IntentService} responsible for handling GCM messages. |
| | */ |
| | public class GCMIntentService extends GCMBaseIntentService { |
| | @SuppressWarnings(“hiding”) |
| | private static final String TAG = “GCM_Intent”; |
| | public GCMIntentService( ) { |
| | super(YoicsServiceSettings.YOICS_NOTIFICATION_ |
| | GCM_SENDER); |
| | } |
| | @Override |
| | protected void onRegistered(Context context, String regid) { |
| | // Send broadcast message so activity can complete server side |
| | NotificationAPIManager.broadcastRegistrationID(context, |
| | regid); |
| | } |
| | @Override |
| | protected void onUnregistered(Context context, String |
| | registrationId) { |
| | // displayMessage(context, getString(R.string.gcm_ |
| | unregistered)); |
| | if (GCMRegistrar.isRegisteredOnServer(context)) { |
| | // Delete the saved registrastion id |
| | } |
| | } |
| | @Override |
| | protected void onMessage(Context context, Intent intent) { |
| | try { |
| | // pull the message sent from the server out of the intent. |
| | String message = intent.getStringExtra(“data.message”); |
| | String title = intent.getStringExtra(“data.title”); |
| | String devicename = intent.getStringExtra(“data. |
| | devicename”); |
| | String timestamp = intent.getStringExtra(“data. |
| | timestamp”); |
| | String uid = intent.getStringExtra(“data.deviceuid”); |
| | // Let the Main activity know we are done, let's send |
| | Intent i = new |
| | Intent(NotificationAPIManager.NOTIFICATION_RECEIVED); |
| | i.putExtra(“message”, message); |
| | i.putExtra(“devicename”, devicename); |
| | i.putExtra(“timestamp”, timestamp); |
| | i.putExtra(“deviceuid”, uid); |
| | i.putExtra(“title”, title); |
| | context.sendBroadcast(i); |
| | } catch (Exception error) ( |
| | Log.e(“GCMReceiver”, “HandleMessage: ” + error. |
| | toString( )); |
| | } |
| | } |
| | @Override |
| | protected void on DeletedMessages(Context context, int total) { |
| | // String message = getString(R.string.gcm_deleted, total); |
| | } |
| | @Override |
| | public void onError(Context context, String errorId) { |
| | // displayMessage(context, getString(R.string.gcm_error, |
| | errorId)); |
| | } |
| | @Override |
| | protected boolean onRecoverableError(Context context, |
| | String errorId) { |
| | // displayMessage(context, getString(R.string.gcm_ |
| | recoverable_error, |
| | // errorId)); |
| | return super.onRecoverableError(context, errorId); |
| | } |
| | } |

Notification Broadcast Receiver—

The Notification Broadcast Receiver receives messages from the GCM Intent and the JPush Receiver and the Yoics Notification SDK. This receiver standardizes the broadcast interface to the main activity and must be in the same package as the activity but may be re-written based on the application's needs as shown in Table 54, in an exemplary embodiment.

TABLE 36

| Ref | Information |
|---|---|
| | private BroadcastReceiver mRegistrationReceiver = new BroadcastReceiver( ) { |
| | @Override |
| | public void onReceive(Context context, Intent intent) { |
| | String action = intent.getAction( ); |
| | if (action |
| | .equalsIgnoreCase(NotificationAPIManager.NOTIFICATION_REGISTRATION_DONE)) |
| | { |
| | Bundle extra = intent.getExtras( ); |
| | String regid = extra.getString(“registrationid”); |
| | try { |
| | if (mToken != null && mUsername != null) { |
| | // register the push token at Yoics |
| | mAPI.registerNotificationAsync(regid); |
| | // save the push token for next login |
| | PreferencesManager.saveNotificationToken(regid, |
| | mPreferences); |
| | // announce the completion |
| | try { |
| | Message myMessage = new |
| | Message( ); |
| | myMessage.obj = “Notification |
| | Registered on Receive”; |
| | handler.sendMessage(myMessage); |
| | } catch (Exception e) { |
| | } |
| | } |
| | } catch (Exception ex) { |
| | } |
| | } else if (action |
| | .equalsIgnoreCase(NotificationAPIManager.NOTIFICATION_RECEIVED)) { |
| | Bundle extra = intent.getExtras( ); |
| | String deviceuid = extra.getString(“deviceuid”); |
| | String title = extra.getString(“title”); |
| | String message = extra.getString(“message”); |
| | String timestamp = extra.getString(“timestamp”); |
| | String devicename = extra.getString(“devicename”); |
| | try { |
| | // announce the notification |
| | try { |
| | Message myMessage = new |
| | Message( ); |
| | myMessage.obj = “Notification |
| | Received from ” + devicename + “ at ” + timestamp; |
| | handler.sendMessage(myMessage); |
| | } catch (Exception e) { |
| | } |
| | } catch (Exception ex) { |
| | } |
| | } |
| | } |
| | }; |

Android JPush Component Examples—

Configuring JPush from an Android app requires setting up the Manifest, instantiating the Yoics Notification API for JPush, and responding to the JPush broadcast Intents.

### JPush Manifest Settings

An exemplary JPush Manifest Settings embodiment is shown in Table 55.

TABLE 37

| Ref | Information |
|---|---|
| | <!-- Required for JPush --> |
| | <permission android:name=“net.yoics.launcher.permission.JPUSH_MESSAGE” |
| | android:protectionLevel=“signature” /> |
| | <uses-permission android:name=“net.yoics.launcher.permission.JPUSH_MESSAGE” /> |
| | <uses-permission android:name=“android.permission.RECEIVE_USER_PRESENT” /> |
| | <uses-permission android:name=“android.permission.INTERNET” /> |
| | <uses-permission android:name=“android.permission.WAKE_LOCK” /> |
| | <uses-permission android:name=“android.permission.READ_PHONE_STATE” /> |
| | <uses-permission |
| | android:name=“android.permission.WRITE_EXTERNAL_STORAGE” /> |
| | <uses-permission android:name=“android.permission.READ_EXTERNAL_STORAGE” |
| | /> |
| | <uses-permission android:name=“android.permission.VIBRATE” /> |
| | <uses-permission |
| | android:name=“android.permission.MOUNT_UNMOUNT_FILESYSTEMS” /> |
| | <uses-permission android:name=“android.permission.ACCESS_NETWORK_STATE” |
| | /> |
| | <uses-permission android:name=“android.permission.SYSTEM_ALERT_WINDOW”/> |
| | /* Required for JPush Notification */ |
| | <meta-data android:name=“JPUSH_APPKEY” |
| | android:value=“422495f659ca790ee1ddf740” /> // Replace with Registered JPush App |
| | Key |
| | <meta-data android:name=“JPUSH_CHANNEL” |
| | android:value=“net.yoics.lanuncher” /> // Replace with Registered Java PAckage for |
| | App |
| | <!-- Yoics JPush Receiver --> |
| | <!-- User defined. For test only [symbol] [symbol] --> |
| | <receiver |
| | android:name=“net.yoics.launcher.JPushReceiver” |
| | android:enabled=“true”> |
| | <intent-filter> |
| | <action android:name=“cn.jpush.android.intent.REGISTRATION” /> <!-- |
| | Required [symbol] SDK [symbol] intent--> |
| | <action android:name=“cn.jpush.android.intent.UNREGISTRATION” /> |
| | <action android:name=“cn.jpush.android.intent.MESSAGE_RECEIVED” /> <!-- |
| | Required [symbol] SDK [symbol] intent--> |
| | <action android:name=“cn.jpush.android.intent.NOTIFICATION_RECEIVED” /> |
| | <!--Required [symbol] SDK [symbol] intent--> |
| | <action android:name=“cn.jpush.android.intent.NOTIFICATION_OPENED” /> |
| | <!--Required [symbol] [symbol] intent--> |
| | <action |
| | android:name=“cn.jpush.android.intent.ACTION_RICHPUSH_CALLBACK”/> <!-- |
| | Optional [symbol] Rich Push Javascript [symbol] intent--> |
| | <category android:name=“net.yoics.launcher” /> |
| | </intent-filter> |
| | </receiver> |
| | <!-- Required for JPush SDK --> |
| | <activity |
| | android:name=“cn.jpush.android.ui.PushActivity” |
| | android:theme=“@android:style/Theme.Translucent.NoTitleBar” |
| | android:configChanges=“orientation\|keyboardHidden” > |
| | <intent-filter> |
| | <action android:name=“cn.jpush.android.ui.PushActivity” /> |
| | <category android:name=“android.intent.category.DEFAULT” /> |
| | <category android:name=“net.yoics.launcher” /> |
| | </intent-filter> |
| | </activity> |
| | <!-- Required SDK [symbol] --> |
| | <service |
| | android:name=“cHpush.android.service.DownloadService” |
| | android:enabled=“true” |
| | android:exported=“false” > |
| | </service> |
| | <!-- Required SDK [symbol] --> |
| | <service |
| | android:name=“cn.jpush.android.service.PushService” |
| | android:enabled=“true” |
| | android:exported=“false”> |
| | <intent-filter> |
| | <action android:name=“cn.jpush.android.intent.REGISTER” /> |
| | <action android:name=“cn.jpush.android.intent.REPORT” /> |
| | <action android:name=“cn.jpush.android.intent.PushService” /> |
| | <action android:name=“cn.jpush.android.intent.PUSH_TIME” /> |
| | </intent-filter> |
| | </service> |
| | <!-- Required SDK [symbol] --> |
| | <receiver |
| | android:name=“cn.jpush.android.service.PushReceiver” |
| | android:enabled=“true” > |
| | <intent-filter android:priority=“1000”> |
| | <action |
| | android:name=“cn.jpush.android.intent.NOTIFICATION_RECEIVED_PROXY” /> <!-- |
| | Required [symbol] --> |
| | <category android:name=“net.yoics.launcher” /> |
| | </intent-filter> |
| | <intent-filter> |
| | <action android:name=“android.intent.action.USER_PRESENT” /> |
| | <action android:name=“android.net.conn.CONNECTIVITY_CHANGE” /> |
| | </intent-filter> |
| | <!-- Optional --> |
| | <intent-filter> |
| | <action android:name=“android.intent.action.PACKAGE_ADDED” /> |
| | <action android:name=“android.intent.action.PACKAGE_REMOVED” /> |
| | <data android:scheme=“package” /> |
| | </intent-filter> |
| | </receiver> |
| | <!-- Required SDK [symbol] --> |
| | <receiver android:name=“cn.jpush.android.service.AlarmReceiver” /> |

### Initiate Yoics Notification for JPush

An exemplary Yoics Notification for JPush initiation is shown in Table 56, in one embodiment.

TABLE 38

| Ref | Information |
|---|---|
| 1 | mAPI = new NotificationAPIManager(mUsername, mUserEmail, |
| 2 | YoicsServiceSettings.YOICS_NOTIFICATION_API_SERVER, |
| 3 | YoicsServiceSettings.YOICS_API_KEY, |
| 4 | YoicsServiceSettings.YOICS_API_USE_SSL, mToken, |
| 5 | this.getApplicationContext( )); |
| 6 | mAPI.setJPushNotification(YoicsServiceSettings.YOICS_ |
| | NOTIFICATION_DOMAIN); |
| 7 | mAPI.registerWithPushSystem( ); |

JPush Receiver—

The JPush Receiver handles the messages received from JPush. Upon receiving a message, the receiver packages the message into a standard broadcast message and sends it to the broadcast receiver as shown in Table 57. Refer to the GCM components for information on the broadcast receiver.

TABLE 39

| Ref | Information |
|---|---|
| | package net.yoics.launcher; |
| | import java.util.Iterator; |
| | import java.util.Map; |
| | import java.util.HashMap; |
| | import net.yoicssdk.service.NotificationAPIManager; |
| | import org.json.JSONObject; |
| | import android.content.BroadcastReceiver; |
| | import android.content.Context; |
| | import android.content.Intent; |
| | import android.os.Bundle; |
| | import android.util.Log; |
| | import cn.jpush.android.api.JPushInterface; |
| | public class JPushReceiver extends BroadcastReceiver { |
| | private static final String TAG = “JPushReceiver”; |
| | @Override |
| | public void onReceive(Context context, Intent intent) { |
| | Bundle bundle = intent.getExtras( ); |
| | if |
| | (JPushInterface.ACTION_MESSAGE_RECEIVED.equals |
| | (intent.getAction( ))) { |
| | String message = |
| | bundle.getString(JPushInterface.EXTRA_MESSAGE); |
| | String extras = |
| | bundle.getString(JPushInterface.EXTRA_EXTRA); |
| | try { |
| | JSONObject jsonObject = new JSONObject(extras); |
| | Iterator keys = jsonObject.keys( ); |
| | Map<String, String> map = new HashMap<String, String>( ); |
| | while (keys.hasNext( )) { |
| | String key = (String) keys.next( ); |
| | map.put(key, jsonObject.getString(key)); |
| | } |
| | System.out.printIn(map);// this map will contain your json |
| | stuff |
| | // pull the message sent from the server out of the intent. |
| | String app_name = “Yoics”; |
| | String msg = (String)map.get(“message”); |
| | String title = (String)map.get(“title”); |
| | String uid = (String)map.get(“deviceuid”); |
| | String timestamp = (String)map.get(“timestamp”); |
| | String devicename = (String)map.get(“devicename”); |
| | // Let the Main activity know we are done, let's send |
| | Intent i = new |
| | Intent(NotificationAPIManager.NOTIFICATION_RECEIVED); |
| | i.putExtra(“message”, message); |
| | i.putExtra(“devicename”, devicename); |
| | i.putExtra(“timestamp”, timestamp); |
| | i.putExtra(“deviceuid”, uid); |
| | i.putExtra(“title”, title); |
| | context.sendBroadcast(i); |
| | } catch (Exception error) { |
| | Log.e(“GCMReceiver”, “HandleMessage: ” + |
| | error.toString( )); |
| | } |
| | } else { |
| | Log.d(TAG, “Unhandled intent - ” + intent.getAction( )); |
| | } |
| | } |
| | } |

Uptube Configuration Parameters—

For Maxim Camera platforms, the UpTube daemon handles notification delivery services. The following sections describe the required configuration to enable notification features. UpTube has a number of configurable options for the second generation notification system. These options are controlled by entries in the configuration (e.g., config.lua) file.

Enabling and Disabling the Second Generation Notification System—

This entry is used to enable or disable the second generation notification system as shown in Table 58, in one embodiment.

TABLE 40

| Ref | Information |
|---|---|
| 1 | NOTIFY2_SERVER_ACTIVE=n |
| 2 | Where |
| 3 | n = 0 notification system is off |
| 4 | n = 1 notification system is on |

Notify Server Count—

This entry designates the number of notification servers available as shown in Table 59, in one embodiment.

TABLE 41

| Ref | Information |
|---|---|
| 1 | NOTIFY2_SERVER_COUNT=n |
| 2 | Where |
| 3 | n = number of servers available for notification |
| 4 | Example: If there were 2 servers the entry would appear as: |
| 5 | NOTIFY2_SERVERS_COUNT=2 |

Notify Server Name List—

This entry specifies the list of available notification servers as shown in Table 60, in an example embodiment.

TABLE 60

| Ref | Information |
|---|---|
| 1 | NOTIFY2_SERVER_LIST=“<server>;<server>;<server>;<server>;...” |
| 2 | Where |
| 3 | <server> = server name |
| 4 | Example: assume 2 servers with the names notify1.yoics.com and |
| | notify2.yoics.com the entry would appear as: |
| 5 | NOTIFY2_SERVER_LIST=“notify1.yoics.com;notify2.yoics.com” |

Notify Server Request for Transaction Code Template—

An example request is shown Table 61.

TABLE 61

| Ref | Information |
|---|---|
| 1 | NOTIFY2_TRANS_CODE_REQ_TEMPLATE=“<template>” |
| 2 | Example: Below is the template as it accepted today: |
| 3 | NOTIFY2_TRANS_CODE_REQ_TEMPLATE=“http://<server>/request_code.php?uid= |
| | <uid>&type=<respformat>” |
| 4 | Uptube replaces: |
| 5 | <server > with one of the servers from the server list |
| 6 | <uid> with the device ID. |

Notify Server Send Notification Request Template—

This template specifies how the request for notification should be formatted as shown in Table 62, in one embodiment.

TABLE 42

| Ref | Information | |
|---|---|---|
| 1 | NOTIFY2_SEND_REQ_TEMPLATE=“<template>” | |
| 2 | Example: The template below is the current accepted format | |
| 3 | NOTIFY2_SEND_REQ_TEMPLATE=“http://<server>/send_notification.php?transaction_ | |
| | code=<transactioncode>&uid=<uid>&device_type=<devicetype>&event_type= | |
| | <eventtype>&timestamp=<timestamp>&message=<message>&status=<status>&transaction_ | |
| | hash=<transactionhash>>&type=<respformat>” | |
| 4 | Uptube replaces: | |
| 5 | <server> | with one of the servers from the server list |
| 6 | <transactioncode> | with a transaction code returned from the server |
| 7 | <uid> | with the device id |
| 8 | <devicetype> | with the string provided in config.lua (see above) |
| 9 | <eventtype> | with the event type supplied by camera firmware |
| 10 | <timestamp> | with the event timestamp from the camera firmware |
| 11 | <message> | with the message ie. youtube URL for event video |
| 12 | <status> | with any pending status message |
| 13 | <transactionhash> | with the transaction hash based on the template |

Notify Request Hash Template—

This template designates how the hash string should be assembled before being hashed with the device secret as shown in Table 63, in one embodiment.

TABLE 43

| Ref | Information | |
|---|---|---|
| 1 | NOTIFY2_HASH_TEMPLATE=<template> | |
| 2 | Example: The template below is the current accepted format | |
| 3 | NOTIFY2_HASH_TEMPLATE=“<transactioncode><uid<devicetype><eventtype> | |
| | <timestamp><message><status>” | |
| 4 | Uptube replaces: | |
| 5 | <transactioncode> | with a transaction code returned from the server |
| 6 | <uid> | with the device id |
| 7 | <devicetype> | with the string provided in config.lua (see above) |
| 8 | <eventtype> | with the event type supplied by camera firmware |
| 9 | <timestamp> | with the event timestamp from the camera firmware |
| 10 | <message> | with the message ie. youtube URL for event video |
| 11 | <status> | with any pending status message |

Notify Server Retries—

This entry specifies the maximum number of retries to attempt before discarding the notification. This is a retry count so the total number of attempts will be one more than this value. The server will attempt to send the notification. If that fails it will attempt a maximum of two retries before it discards the notification. Table 64 shows an example embodiment.

TABLE 44

| Ref | Information |
|---|---|
| 1 | NOTIFY2_SERVER_RETRIES=<count> |
| 2 | Where |
| 3 | <count> is the maximum number of retries |
| 4 | Example: |
| 5 | NOTIFY2_SERVER_RETRIES=2 |

Notify Retry Interval—

This entry specifies the time the notification system will delay between retries of a failed notification. In the illustrated embodiment, the value is in seconds. The server will attempt to send the notification. If that fails the notification will not retry the operation for 10 seconds, in the illustrated embodiment. The server will wait up to 10 seconds for a response from the server as shown in the example illustrated in Table 65.

TABLE 45

| Ref | Information |
|---|---|
| 1 | NOTIFY2_SERVER_RETRYINTERVAL=<seconds> |
| 2 | Where |
| 3 | <seconds> is the time to delay between retries |
| 4 | Example: |
| 5 | NOTIFY2_SERVER_RETRYINTERVAL=10 |

Notify Timeout—

This entry specifies the timeout used when waiting for a response from the server. In the illustrated embodiment, the value is specified in seconds. Table 66 shows an example embodiment.

TABLE 46

| Ref | Information |
|---|---|
| 1 | NOTIFY2_SERVER_TIMEOUT=<seconds> |
| 2 | Where |
| 3 | <seconds> is the timeout value to be used |
| 4 | Example: |
| 5 | NOTIFY2_SERVER_TIMEOUT=10 |

Transaction Hash—

A notification request must include a transaction hash parameter to be valid. This parameter is an “hmac sha1” hash with selected fields from the request hashed with the device “secret”. The hash fields are determined by a template specified in the configuration file.

### Additional Embodiments of the Disclosure

### Additional Practical Application Examples

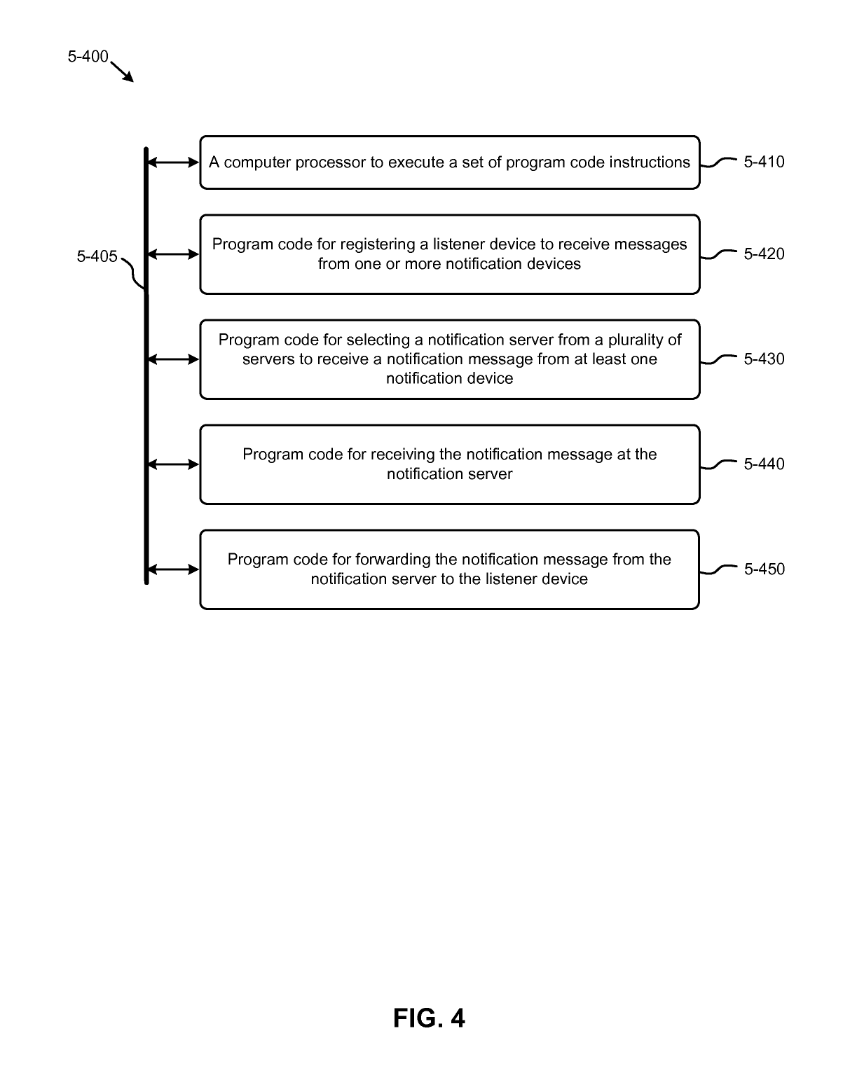

FIG. 4 is a block diagram of a system 5-400 for implementing all or portions of any of the embodiments described herein. System 5-400 comprises at least one processor and at least one memory, the memory serving to store program instructions corresponding to the operations of the system. As shown, an operation can be implemented in whole or in part using program instructions accessible by a module. The modules are connected to a communication path 5-405, and any operation can communicate with other operations over communication path 5-405. The modules of the system can, individually or in combination, perform method operations within system 5-400. Any operations performed within system 5-400 may be performed in any order unless as may be specified in the claims.

FIG. 4 depicts a block diagram of a system to perform certain functions of a computer system. As an option, the present system 5-400 may be implemented in the context of the architecture and functionality of the embodiments described herein. Of course, however, the system 5-400 or any operation therein may be carried out in any desired environment. The embodiment of FIG. 4 implements a portion of a computer system, shown as system 5-400, comprising a computer processor to execute a set of program code instructions (see module 5-410) and modules for accessing memory to hold program code instructions to perform: registering a listener device to receive messages from one or more notification devices (see module 5-420); selecting a notification server from a plurality of servers to receive a notification message from at least one notification device (see module 5-430); receiving the notification message at the notification server (see module 5-440); and forwarding the notification message from the notification server to the listener device (see module 5-450).

Some embodiments receive the notification message being contained within an IP protocol message directed to a first function, which is intercepted a processor that emulates the first function, which processor then modifies the IP protocol message to emulate a second function that is different from the first function.

Further details regarding general approaches to modifying an IP protocol message to emulate a second function that is different from a first function are described in U.S. application Ser. No. 13/918,773, titled “NETWORKING SYSTEMS” filed Jun. 14, 2013, (Attorney DocketID YOICP0003) which is hereby incorporated by reference in its entirety.

### System Architecture Overview

### Additional System Architecture Examples

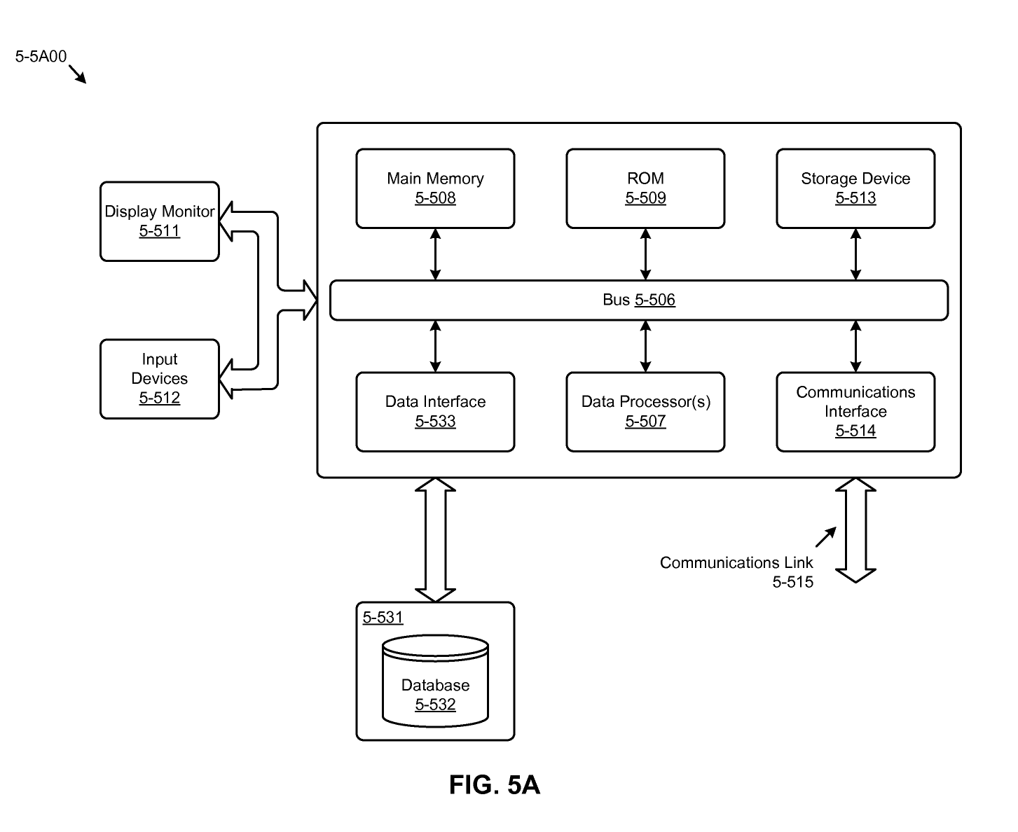

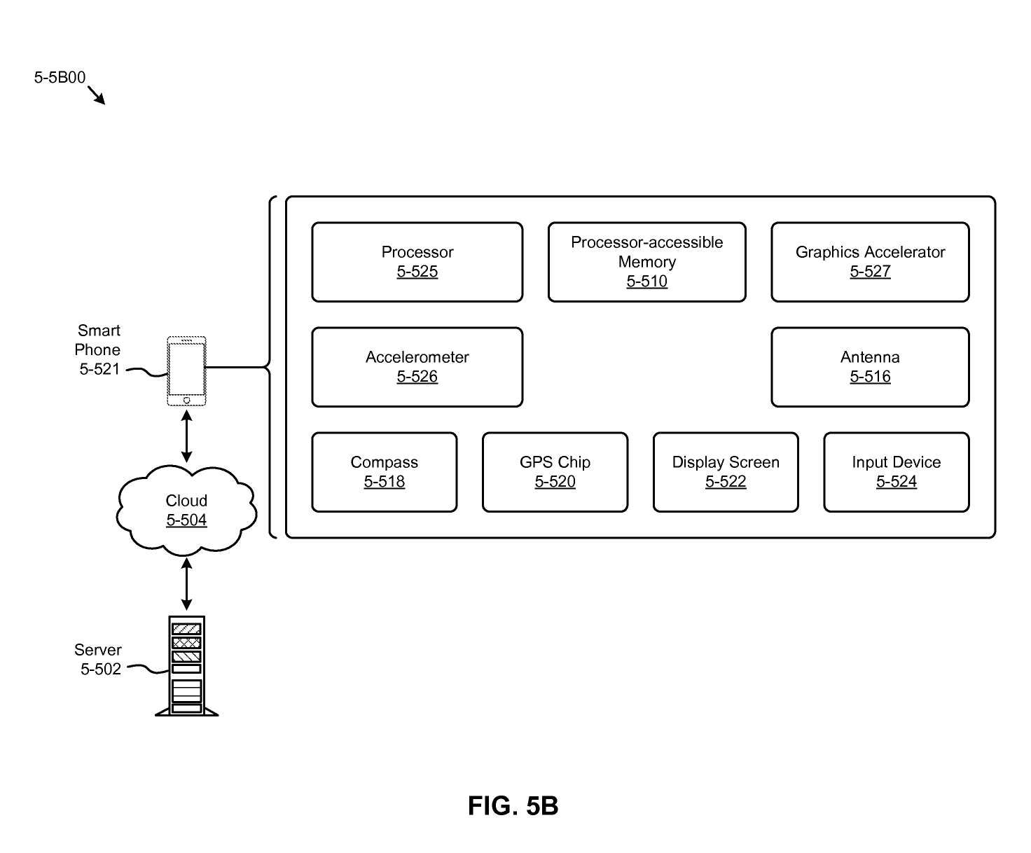

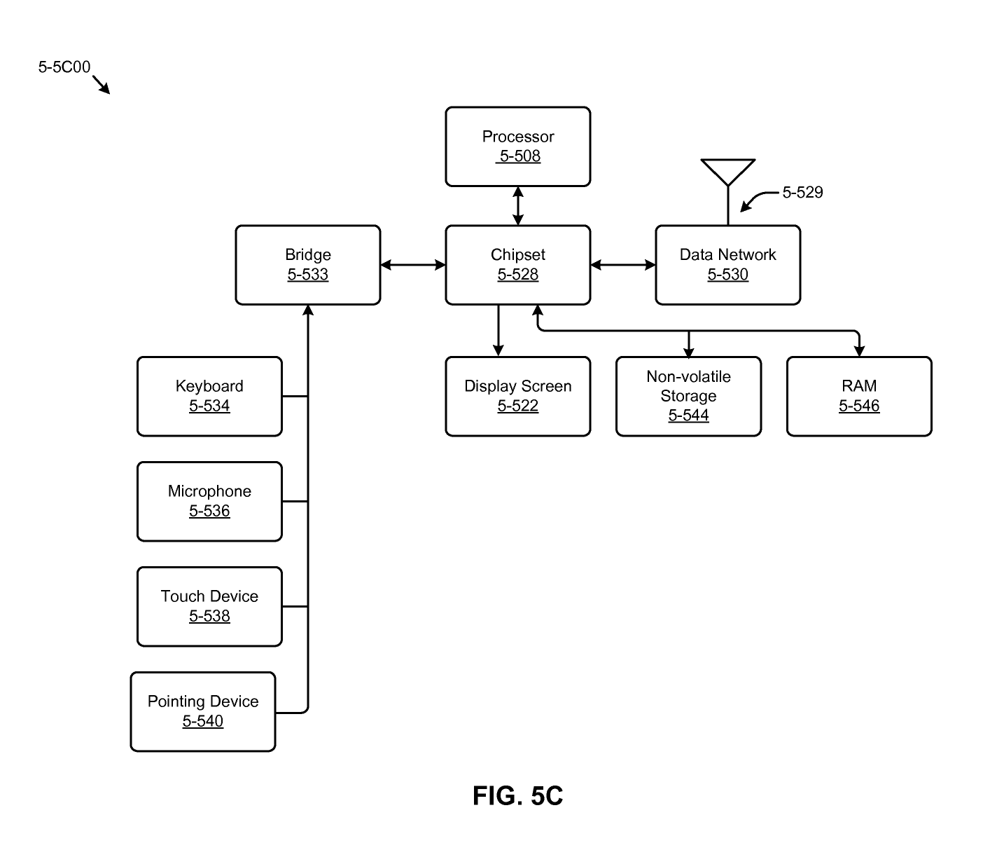

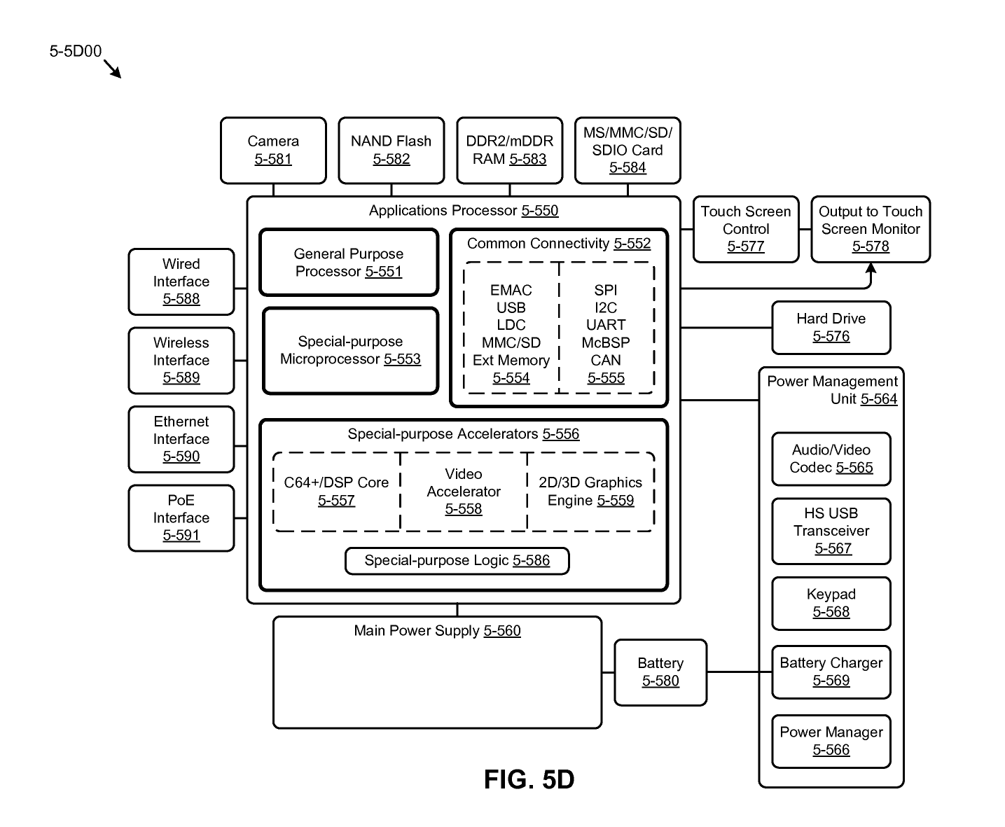

FIG. 5A depicts a block diagram of an instance of a computer system 5-500 suitable for implementing embodiments of the present disclosure. Computer system 5-500 includes a bus 5-506 or other communication mechanism for communicating information, which interconnects subsystems and devices such as a data processor 5-507, a system memory (e.g., main memory 5-508, or an area of random access memory RAM), a static storage device (e.g., ROM 5-509), a storage device 5-513 (e.g., magnetic or optical), a data interface 5-533, a communications interface 5-514 (e.g., modem or Ethernet card), a display monitor 5-511 (e.g., CRT or LCD), input devices 5-512 (e.g., keyboard, cursor control), and an external data repository 5-531.

According to one embodiment of the disclosure, computer system 5-500 performs specific operations by data processor 5-507 executing one or more sequences of one or more instructions contained in system memory. Such instructions may be read into system memory from another computer readable/usable medium such as a static storage device or a disk drive. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to data processor 5-507 for execution. Such a medium may take many forms including, but not limited to, non-volatile media and volatile media. Non-volatile media includes, for example, optical or magnetic disks such as disk drives or tape drives. Volatile media includes dynamic memory such as a RAM memory.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 5-500. According to certain embodiments of the disclosure, two or more instances of computer system 5-500 coupled by a communications link 5-515 (e.g., LAN, PTSN, or wireless network) may perform the sequence of instructions required to practice the disclosure in coordination with one another.

Computer system 5-500 may transmit and receive messages, data, and instructions including programs (e.g., application code), through communications link 5-515 and communications interface 5-514. Received program code may be executed by data processor 5-507 as it is received and/or stored in storage device 5-513 or any other non-volatile storage for later execution. Computer system 5-500 may communicate through a data interface 5-533 to a database 5-532 on an external data repository 5-531. Data items in database 5-532 can be accessed using a primary key (e.g., a relational database primary key). A module as used herein can be implemented using any mix of any portions of the system memory and any extent of hard-wired circuitry including hard-wired circuitry embodied as a data processor 5-507. Some embodiments include one or more special-purpose hardware components (e.g., power control, logic, sensors, etc.).

FIG. 5B is a diagram illustrating a mobile terminal (see smart phone architecture 5-5A00), in one embodiment. As shown, the smart phone 5-521 includes a housing, display screen, and interface device, which may include a button, microphone, and/or touch screen. In certain embodiments, a smart phone has a high resolution camera device, which can be used in various modes. An example of a smart phone can be an iPhone from Apple Inc. of Cupertino, Calif. Alternatively, a smart phone can be a Galaxy from Samsung, or others.

In a particular example, the smart phone may include one or more of the following features (which are found in an iPhone from Apple Inc., although there can be variations).
GSM model: UMTS/HSDPA/HSUPA (850, 900, 1900, 2100 MHz); GSM/EDGE (850, 900, 1800, 1900 MHz)
CDMA model: CDMA EV-DO Rev. A (800, 1900 MHz)
802.11b/g/n Wi-Fi (802.11n 2.4 GHz only)
Bluetooth 2.1+EDR wireless technology
Assisted GPS
Digital compass
Wi-Fi
Cellular
Retina display
3.5-inch (diagonal) widescreen multi-touch display
800:1 contrast ratio (typical)
500 cd/m2 max brightness (typical)
Fingerprint-resistant oleophobic coating on front and back
Support for display of multiple languages and characters simultaneously
5-megapixel iSight camera
Video recording, HD (720p) up to 30 frames per second with audio
VGA-quality photos and video at up to 30 frames per second with the front camera
Tap to focus video or still images
LED flash
Photo and video geotagging
Built-in rechargeable lithium-ion battery
Charging via USB to computer system or power adapter
Talk time: Up to 20 hours on 3G, up to 14 hours on 2G (GSM)
Standby time: Up to 300 hours
Internet use: Up to 6 hours on 3G, up to 10 hours on Wi-Fi
Video playback: Up to 10 hours
Audio playback: Up to 40 hours
Frequency response: 20 Hz to 22,000 Hz
Audio formats supported: AAC (8 to 320 Kbps), protected AAC (from iTunes Store), HE-AAC, MP3 (8 to 320 Kbps), MP3 VBR, audible (formats 2, 3, 4, audible enhanced audio, AAX, and AAX+), Apple lossless, AIFF, and WAV
User-configurable maximum volume limit
Video out support with Apple digital AV adapter or Apple VGA adapter; 576p and 480p with Apple component AV cable; 576i and 480i with Apple composite AV cable (cables sold separately)
Video formats supported: H.264 video up to 1080p, 30 frames per second, main profile Level 3.1 with AAC-LC audio up to 160 Kbps, 48 kHz, stereo audio in .m4v, .mp4, and .mov file formats; MPEG-4 video up to 2.5 Mbps, 640 by 480 pixels, 30 frames per second, simple profile with AAC-LC audio up to 160 Kbps per channel, 48 kHz, stereo audio in .m4v, .mp4, and .mov file formats; motion JPEG (M-JPEG) up to 35 Mbps, 1280 by 1020 pixels, 30 frames per second, audio in ulaw, PCM stereo audio in .avi file format
Three-axis gyro
Accelerometer
Proximity sensor
Ambient light sensor, etc.

Embodiments of the present disclosure may be used with other mobile terminals. Examples of suitable mobile terminals include a portable mobile terminal such as a media player, a cellular phone, a personal data organizer, or the like. In such embodiments, a portable mobile terminal may include a combination of the functionalities of such devices. In addition, a mobile terminal may allow a user to connect to and communicate through the Internet or through other networks such as local or wide area networks. For example, a portable mobile terminal may allow a user to access the internet and to communicate using email, text messaging, instant messaging, or using other forms of electronic communication. By way of example, the mobile terminal may be similar to an iPod having a display screen or an iPhone available from Apple, Inc.

In certain embodiments, a device may be powered by one or more rechargeable and/or replaceable batteries. Such embodiments may be highly portable, allowing a user to carry the mobile terminal while traveling, working, exercising, and so forth. In this manner, and depending on the functionalities provided by the mobile terminal, a user may listen to music, play games or video, record video or take pictures, place and receive telephone calls, communicate with others, control other devices (e.g., via remote control and/or Bluetooth functionality), and so forth while moving freely with the device. In addition, the device may be sized such that it fits relatively easily into a pocket or the hand of the user. While certain embodiments of the present disclosure are described with respect to portable mobile terminals, it should be noted that the presently disclosed techniques may be applicable to a wide array of other, less portable, mobile terminals and systems that are configured to render graphical data, such as a desktop computer.

The smart phone 5-521 is configured to communicate with a server 5-502 in electronic communication with any forms of handheld mobile terminals. Illustrative examples of such handheld mobile terminals can include functional components such as a processor 5-525, processor-accessible memory 5-510, graphics accelerator 5-527, accelerometer 5-526, communications interface 5-514 (possibly including an antenna 5-516), compass 5-518, GPS chip 5-520, display screen 5-522, and an input device 5-524. Each device is not limited to the illustrated components. The components may be hardware, software or a combination of both.

In some examples, instructions can be input to the handheld mobile terminal through an input device 5-524 that instructs the processor 5-525 to execute functions in an electronic imaging application. One potential instruction can be to generate an abstract of a captured image of a portion of a human user. In such a case the processor 5-525 instructs the communications interface 5-514 to communicate with the server 5-502 (e.g., possibly through or using a cloud 5-504) and transfer data (e.g., image data). The data is transferred by the communications interface 5-514 and either processed by the processor 5-525 immediately after image capture or stored in processor-accessible memory 5-510 for later use, or both. The processor 5-525 also receives information regarding the display screen's attributes, and can calculate the orientation of the device, e.g., using information from an accelerometer 5-526 and/or other external data such as compass headings from a compass 5-518, or GPS location from a GPS chip 5-520, and the processor then uses the information to determine an orientation in which to display the image depending upon the example.

The captured image can be rendered by the processor 5-525, by a graphics accelerator 5-527, or by a combination of the two. In some embodiments, the processor can be the graphics accelerator 5-527. The image can first be stored in processor-accessible memory 5-510 or, if available, the memory can be directly associated with the graphics accelerator 5-527. The methods described herein can be implemented by the processor 5-525, the graphics accelerator 5-527, or a combination of the two to create the image and related abstract. An image or abstract can be displayed on the display screen 5-522.

FIG. 5C depicts an interconnection of components to form a mobile terminal 5-5C00, in one embodiment. Examples of mobile terminals include an enclosure or housing, a display, user input structures, and input/output connectors in addition to the aforementioned interconnection of components. The enclosure may be formed from plastic, metal, composite materials, or other suitable materials, or any combination thereof. The enclosure may protect the interior components of the mobile terminal from physical damage, and may also shield the interior components from electromagnetic interference (EMI).

The display may be a liquid crystal display (LCD), a light emitting diode (LED) based display, an organic light emitting diode (OLED) based display, or some other suitable display. In accordance with certain embodiments of the present disclosure, the display may display a user interface and various other images such as logos, avatars, photos, album art, and the like. Additionally, in certain embodiments, a display may include a touch screen through which a user may interact with the user interface. The display may also include various functions and/or system indicators to provide feedback to a user such as power status, call status, memory status, or the like. These indicators may be incorporated into the user interface displayed on the display.

In certain embodiments, one or more of the user input structures can be configured to control the device such as by controlling a mode of operation, an output level, an output type, etc. For instance, the user input structures may include a button to turn the device on or off. Further, the user input structures may allow a user to interact with the user interface on the display. Embodiments of the portable mobile terminal may include any number of user input structures including buttons, switches, a control pad, a scroll wheel, or any other suitable input structures. The user input structures may work with the user interface displayed on the device to control functions of the device and/or any interfaces or devices connected to or used by the device. For example, the user input structures may allow a user to navigate a displayed user interface or to return such a displayed user interface to a default or home screen.

Certain devices may also include various input and output ports to allow connection of additional devices. For example, a port may be a headphone jack that provides for the connection of headphones. Additionally, a port may have both input and output capabilities to provide for the connection of a headset (e.g., a headphone and microphone combination). Embodiments of the present disclosure may include any number of input and/or output ports such as headphone and headset jacks, universal serial bus (USB) ports, IEEE-1394 ports, and AC and/or DC power connectors. Further, a device may use the input and output ports to connect to and send or receive data with any other device such as other portable mobile terminals, personal computers, printers, or the like. For example, in one embodiment, the device may connect to a personal computer via an IEEE-1394 connection to send and receive data files such as media files.

The depiction of mobile terminal 5-5C00 illustrates computer hardware, software, and firmware that can be used to implement the disclosures above. The shown system includes a processor that is representative of any number of physically and/or logically distinct resources capable of executing software, firmware, and hardware configured to perform identified computations. A processor communicates with a chipset 5-528 that can control input to and output from processor. In this example, chipset 5-528 outputs information to display screen 5-522 and can read and write information to non-volatile storage 5-544, which can include magnetic media and solid state media, and/or other non-transitory media, for example. Chipset 5-528 can also read data from and write data to RAM 5-546. A bridge 5-533 for interfacing with a variety of user interface components can be provided for interfacing with chipset 5-528. Such user interface components can include a keyboard 5-534, a microphone 5-536, touch-detection-and-processing circuitry 5-538, a pointing device 5-540 such as a mouse, and so on. In general, inputs to the system can come from any of a variety of machine-generated and/or human-generated sources.

Chipset 5-528 also can interface with one or more data network interfaces 5-530 that can have different physical interfaces. Such data network interfaces 5-530 can include interfaces for wired and wireless local area networks, for broadband wireless networks, as well as personal area networks. Some applications of the methods for generating, displaying and using the GUI disclosed herein can include receiving data over a physical interface 5-529 or be generated by the machine itself by a processor analyzing data stored in non-volatile storage 5-544 and/or in memory or RAM 5-546. Further, the machine can receive inputs from a user via devices such as a keyboard 5-534, microphone 5-536, touch-detection-and-processing circuitry 5-538, and pointing device 5-540 and execute appropriate functions such as browsing functions by interpreting these inputs using processor 5-525.

FIG. 5D depicts a deployable device architecture 5-5D00, in one embodiment. The deployable device architecture comprises an applications processor 5-550 which in turn comprises a general purpose processor 5-551, a block for common connectivity 5-552, and any number of accelerators 5-556, which may include one or more of a DSP core 5-557, a video accelerator 5-558, and a graphics engine 5-559, and/or any forms of Special-purpose Logic 5-586. Such a deployable device architecture may comprise multiple volatile and non-volatile memory segments such as NAND flash 5-582, RAM 5-583, one or more instances of a memory card 5-584, and/or one or more instances of a hard drive 5-576.

The architecture may further comprise various I/O modules such as a camera 5-581, a touch screen controls 5-577, a monitor 5-578, and other I/O, which may comprise analog transducers. Any one or more components within the deployable device architecture may be powered by a power supply 5-560 and/or a battery 5-580. Connectivity is supported for any standard or protocols as shown in block 5-554 and/or in block 5-555, and can further comprise one or more instances of a wired interface 5-588 and/or a wireless interface 5-589.

Some architectures include a power management unit 5-564, which in turn can manage power for submodules, such as any one or more of the shown audio/video codec 5-565, USB transceiver 5-567, keypad 5-568, and a battery charger 5-569. The power management unit might include a supervisor such as the shown power manager 5-566 that manages and/or prioritizes power regimes.

Network access is facilitated by any one or more networking interfaces, such as any of the shown wired interface 5-588 (e.g., powerline communications), a wireless interface 5-589, an Ethernet interface 5-590, and/or a PoE interface 5-591.

It should be noted that, one or more aspects of the various embodiments of the present disclosure may be included in an article of manufacture (e.g., one or more computer program products) having, for instance, computer usable media. The media has embodied therein, for instance, computer readable program code for providing and facilitating the capabilities of the various embodiments of the present disclosure. The article of manufacture can be included as a part of a computer system or sold separately.

Additionally, one or more aspects of the various embodiments of the present disclosure may be designed using computer readable program code for providing and/or facilitating the capabilities of the various embodiments or configurations of embodiments of the present disclosure.

Additionally, one or more aspects of the various embodiments of the present disclosure may use computer readable program code for providing and facilitating the capabilities of the various embodiments or configurations of embodiments of the present disclosure and that may be included as a part of a computer system and/or memory system and/or sold separately.

Additionally, at least one program storage device readable by a machine, tangibly embodying at least one program of instructions executable by the machine to perform the capabilities of the various embodiments of the present disclosure can be provided.

The diagrams depicted herein are just examples. There may be many variations to these diagrams or the steps (or operations) described therein without departing from the spirit of the various embodiments of the disclosure. For instance, the steps may be performed in a differing order, or steps may be added, deleted or modified.

In various optional embodiments, the features, capabilities, techniques, and/or technology, etc. of the memory and/or storage devices, networks, mobile devices, peripherals, hardware, and/or software, etc. disclosed in the following applications may or may not be incorporated into any of the embodiments disclosed herein.

References in this specification and/or references in specifications incorporated by reference to “one embodiment” may mean that particular aspects, architectures, functions, features, structures, characteristics, etc. of an embodiment that may be described in connection with the embodiment may be included in at least one implementation. Thus references to “in one embodiment” may not necessarily refer to the same embodiment. The particular aspects, etc. may be included in forms other than the particular embodiment described and/or illustrated and all such forms may be encompassed within the scope and claims of the present application.

References in this specification and/or references in specifications incorporated by reference to “for example” may mean that particular aspects, architectures, functions, features, structures, characteristics, etc. described in connection with the embodiment or example may be included in at least one implementation. Thus references to an “example” may not necessarily refer to the same embodiment, example, etc. The particular aspects, etc. may be included in forms other than the particular embodiment or example described and/or illustrated and all such forms may be encompassed within the scope and claims of the present application.

This specification and/or specifications incorporated by reference may refer to a list of alternatives. For example, a first reference such as “A (e.g., B, C, D, E, etc.)” may refer to a list of alternatives to A including (but not limited to) B, C, D, E. A second reference to “A, etc.” may then be equivalent to the first reference to “A (e.g., B, C, D, E, etc.).” Thus, a reference to “A, etc.” may be interpreted to mean “A (e.g., B, C, D, E, etc.).”

It may thus be seen from the examples provided above that the improvements to devices (e.g., as shown in the contexts of the figures included in this specification, for example) may be used in various applications, contexts, environments, etc. The applications, uses, etc. of these improvements, etc. may not be limited to those described above, but may be used, for example, in combination. For example, one or more applications, etc. used in the contexts, for example, in one or more figures may be used in combination with one or more applications, etc. used in the contexts of, for example, one or more other figures and/or one or more applications, etc. described in any specifications incorporated by reference. Further, while various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
registering a listener device to receive messages from one or more notification devices;
selecting a notification server from a plurality of servers to receive a notification message from at least one notification device;
receiving the notification message at the notification server; and
forwarding the notification message from the notification server to the listener device.

2. The method of claim 1, wherein the notification server is selected to load balance the plurality of servers.

3. The method of claim 1, wherein the notification server is selected randomly.

4. The method of claim 1, wherein the notification message is contained within an IP protocol message directed to a first function.

5. The method of claim 4 further comprising intercepting the IP protocol message.

6. The method of claim 5, wherein the IP protocol message is intercepted by a processor that emulates the first function.

7. The method of claim 6 wherein the processor that emulates the first function modifies the IP protocol message to emulate a second function that is different from the first function.

8. A computer program product, embodied in a non-transitory computer readable medium, the computer readable medium having stored thereon a sequence of instructions which, when executed by a processor causes the processor to execute a process, the process comprising:
registering a listener device to receive messages from one or more notification devices;
selecting a notification server from a plurality of servers to receive a notification message from at least one notification device;
receiving the notification message at the notification server; and
forwarding the notification message from the notification server to the listener device.

9. The computer program product of claim 8, wherein the notification server is selected to load balance the plurality of servers.

10. The computer program product of claim 8, wherein the notification server is selected randomly.

11. The computer program product of claim 8, wherein the notification message is contained within an IP protocol message directed to a first function.

12. The computer program product of claim 11 further comprising instructions for intercepting the IP protocol message.

13. The computer program product of claim 12, wherein the IP protocol message is intercepted by a processor that emulates the first function.

14. The computer program product of claim 13 wherein the processor that emulates the first function modifies the IP protocol message to emulate a second function that is different from the first function.

15. A system supporting a listener device and one or more notification devices, the system comprising:
a registration module to register the listener device to receive messages from one or more notification devices;
a firewall module for receiving a notification message from one or more notification devices;
a notification server to forward the notification message to the listener device; and
a load balancer module to select the notification server from a plurality of servers.

16. The system of claim 15, wherein the load balancer module further operates to select the notification server to load balance the plurality of servers.

17. The system of claim 15, wherein the load balancer module further operates to randomly select the notification server.

18. The system of claim 15, wherein the notification message is contained within an IP protocol message directed to a first function.

19. The system of claim 18, wherein the IP protocol message is intercepted by a processor that emulates the first function.

20. The system of claim 19 wherein the processor that emulates the first function modifies the IP protocol message to emulate a second function that is different from the first function.
